(19) United States
(12) Patent Application Publication
(10) Pub. No.: US 2025/0349306 A1
(43) Pub. Date: Nov. 13, 2025

(54) APPARATUS AND METHOD FOR INTERFERENCE CANCELLATION AND FOR SAMPLE RATE OFFSET COMPENSATION FOR A MULTI-DEVICE SCENARIO

(71) Applicants: Fraunhofer-Gesellschaft zur Foerderung der angewandten Forschung e.V., Munich (DE); Friedrich-Alexander-Universitaet Erlangen-Nuernberg, in Vertretung des Freistaates Bayern, Erlangen (DE)

(72) Inventors: Srikanth KORSE, Erlangen (DE); Emanuel HABETS, Erlangen (DE); Oliver THIERGART, Erlangen (DE); Edwin MABANDE, Erlangen (DE)

(21) Appl. No.: 19/201,658

(22) Filed: May 7, 2025

(30) Foreign Application Priority Data
May 7, 2024 (EP) 24174655.1

(51) Int. Cl. G10L 19/03

(52) U.S. Cl. CPC G10L 19/03

(57) ABSTRACT

An apparatus for interference cancellation according to an embodiment is provided. The apparatus comprises a preprocessor configured for resampling a first audio signal to obtain a sampling-rate-adjusted first signal. Moreover, the apparatus comprises an interference estimator configured for estimating a first interference estimate depending on a first filter configuration and depending on the sampling-rate-adjusted first signal; and configured for estimating a second interference estimate depending on a second filter configuration and depending on a second audio signal. Furthermore, the apparatus comprises a signal processor configured for processing a microphone signal or an intermediate signal, being a signal derived from the microphone signal, depending on the first interference estimate and depending on the second interference estimate to obtain an error signal; configured for updating the first filter configuration and the second filter configuration depending on the error signal; and configured for outputting the error signal. The preprocessor is configured to resample the first audio signal depending on a sampling rate offset between a sampling rate of the microphone signal or of the intermediate signal or of the error signal, and a sampling rate of the first audio signal.

### CROSS-REFERENCE TO RELATED APPLICATIONS

This application claims priority from European Patent Application No. 24174655.1 which was filed on May 7, 2024, and is incorporated herein in its entirety by reference.

The present invention relates to audio signal processing, in particular, to an apparatus and a method for interference cancellation for a multi-device scenario, and, more particularly, to an apparatus and a method for interference cancellation for a multi-device scenario. Moreover, the present invention relates to an apparatus and a method for sample rate offset compensation.

### BACKGROUND OF THE INVENTION

Teleconferencing scenarios and human machine interaction suffer from various interferences, e.g., acoustic echoes.

FIG. 8 illustrates such a teleconferencing scenario with two participating users at a location A, with another participating user at a location B, and with a further participating user at a location C. A main client connected to remote participants via conferencing solutions. E.g., the main client may, e.g., be connected to external devices, e.g., via Bluetooth or Wifi. Usually, interference in the form of acoustic echoes are produced from external loudspeakers reproducing the speech and sounds of the remote participants. Moreover, a sample rate offset (SRO) between the devices occurs, e.g., due to differences in the crystal oscillators driving ADCs and DACs.

Or, in another scenario, a human machine interaction may be considered. A main client may, e.g., be connected to external devices via Bluetooth/Wifi. Again, interferences in the form of echoes may, e.g., be produced from loudspeakers, and a sample rate offset (SRO) between the devices occurs due to differences in the crystal oscillators driving ADCs and DACs.

An example of interference cancellation is acoustic echo cancellation (AEC) which is a signal processing technique employed to mitigate the echoes caused by loudspeaker to microphone feedback [1, 2, 3]. In a multi-device setup, AEC should not only eliminate the echoes from the loudspeaker of its own device but also echoes from loudspeaker of other devices at the same location [4, 5, 6]. One key requirement of the AEC is that the reference signals should be synchronized. However, due to the presence of a sampling rate offset (SRO) between the devices [7, 8], the signals are not synchronized causing the performance of AEC to degrade [9, 10, 11, 12, 13].

Degradation of AEC when the signals are asynchronous can be mainly solved in two ways, namely according to synchronous solutions, and according to asynchronous solutions.

Synchronous solutions are solutions, where the far-end signal is initially synchronized with the microphone signal before running the AEC. Pawig et al. [10] estimated the time scaling parameter and used time domain interpolation to synchronize the signals before running the AEC. Abe et al. [11] estimated the SRO in frequency domain using a simple extension of LMS algorithm before rotating the phase of the far-end signal to approximate the time domain resampling. Helwani et al. [13]proposed a novel Kalman filtering approach which blindly accounts for the SRO. Several SRO estimation algorithms belonging to the family of average coherence drift (ACD) [14, 15, 16] have been proposed to tackle the SRO issue in wireless sensor networks. However, synchronous solutions are primarily limited to single-device scenarios.

Asynchronous solutions where the far-end signal is estimated use fixed beamformers [12], thereby, and avoid the explicit need of synchronization. While it is shown to work in multi-device scenario, it faces the problem of near-end speech distortion when the near-end speech leaks into beamformer output. In addition, it requires that the device on which the AEC is running may, e.g., have multiple microphones for beamforming.

While asynchronous solutions do not require synchronization between the far-end and microphone signals., a two stage AEC (internal and external) is employed. For the second stage AEC, the reference signal is obtained by beamforming. Asynchronous solutions are, however, limited to a cancellation or a distortion of a near-end speaker, if leaked into reference signal computed by beamforming.

However, in multi-device scenarios a sampling rate offset between the devices occurs, and due to this sampling rate offset, e.g., the interference filter, e.g., an AEC filter cannot converge and hence, the interferences, e.g., the acoustic echoes, cannot be cancelled. Thus, acoustic echo cancellation in a multi-device scenario is a challenging problem due to the presence of sample rate offset between the devices. The presence of SRO prevents the convergence of the AEC filter thereby reducing the overall performance.

Moreover, regarding other aspects, spatial audio reproduction enables immersive experiences in virtual/augmented reality and teleconferencing.

Spatial audio capturing and reproduction enables a range of applications, for example, virtual/augmented reality, gaming, and immersive teleconferencing [24], [25]. On the playback side, spatial audio reproduction aims to recreate the captured complex acoustic environments, or to construct completely new ones, such that a listener perceives sounds as originating from arbitrary positions in space.

Reproduction typically involves either binaural rendering of spatial formats, for example, Ambisonics [26], object-based audio [25], and channel-based audio [25] for playback over headphones or stereo loudspeakers, or involves loudspeaker-based reproduction using amplitude panning techniques like vector-based amplitude panning (VBAP) [27]. These techniques are often evaluated using a standardized loudspeaker layout (see [28], [29], [30]) in controlled environments, where speakers are arranged at uniform distances around the listener. However, such setups are impractical in domestic settings due to cost and spatial constraints.

To overcome these limitations, traditional evaluations of spatial algorithms use standardized loudspeaker setups in controlled environments, which are, however, often impractical for a home use. Media device orchestration (MDO) has emerged as a flexible approach (see [31], [32]), which leverages a network of heterogeneous devices, for example, laptops, smart speakers, and smartphones, for collaborative spatial rendering. MDO offers a scalable alternative using heterogeneous devices (e.g., laptops, smart speakers, smartphones), but introduces synchronization challenges due to sample rate offset (SRO) from independent device clocks.

However, media device orchestration introduces synchronization challenges, particularly sample rate offsets (SROs) arising from the use of individual clocks. In particular, one of the main challenges in synchronizing wirelessly connected loudspeakers for spatial audio reproduction is clock skew. Clock skew arises from sample rate offsets (SROs) between the loudspeakers, caused by the use of independent device clocks. While network-based protocols like Precision Time Protocol (PTP) and Network Time Protocol (NTP) have been explored, the impact of the effect of SROs on spatial audio reproduction and its perceptual consequences remains underexplored.

This leads to time-varying misalignment of playback signals and degradation of spatial cues. Existing approaches to clock synchronization rely on network-based protocols, for example, Precision Time Protocol (PTP) (see [33]) and Network Time Protocol (NTP) (see [34]), which aims to align device clocks [35], [36]. While network-based protocols like Precision Time Protocol (PTP) and Network Time Protocol (NTP) have been explored, the impact of SRO on spatial audio reproduction and its perceptual consequences on the listener's perception remain underexplored.

### SUMMARY

An apparatus for interference cancellation according to an embodiment is provided. The apparatus comprises a preprocessor configured for resampling a first audio signal to obtain a sampling-rate-adjusted first signal. Moreover, the apparatus comprises an interference estimator configured for estimating a first interference estimate depending on a first filter configuration and depending on the sampling-rate-adjusted first signal; and configured for estimating a second interference estimate depending on a second filter configuration and depending on a second audio signal. Furthermore, the apparatus comprises a signal processor configured for processing a microphone signal or an intermediate signal, being a signal derived from the microphone signal, depending on the first interference estimate and depending on the second interference estimate to obtain an error signal; configured for updating the first filter configuration and the second filter configuration depending on the error signal; and configured for outputting the error signal. The preprocessor is configured to resample the first audio signal depending on a sampling rate offset between a sampling rate of the microphone signal or of the intermediate signal or of the error signal, and a sampling rate of the first audio signal.

Moreover, a method for interference cancellation according to an embodiment is provided. The method comprises:
Resampling a first audio signal to obtain a sampling-rate-adjusted first signal.
Estimating a first interference estimate depending on a first filter configuration and depending on the sampling-rate-adjusted first signal; and configured for estimating a second interference estimate depending on a second filter configuration and depending on a second audio signal.
Processing a microphone signal or an intermediate signal, being a signal derived from the microphone signal, depending on the first interference estimate and depending on the second interference estimate to obtain an error signal; configured for updating the first filter configuration and the second filter configuration depending on the error signal; and configured for outputting the error signal.

Resampling the first audio signal is conducted depending on a sampling rate offset between a sampling rate of the microphone signal or of the intermediate signal or of the error signal, and a sampling rate of the first audio signal.

Furthermore, a computer program according to an embodiment for implementing the above-described method when being executed on a computer or signal processor is provided.

In particular, two variants of two channel AEC according to particular embodiments are provided to solve the two device AEC problem in the presence of SRO and evaluated for both uncorrelated or correlated playback signals in both echo-only and double-talk scenario.

Embodiments are robust to both correlated and uncorrelated playback signals. For correlated playback signals, a local independent AEC filter may, e.g., be useful to ensure faster convergence of the estimated SRO.

Experiments in both echo-only and double-talk cases show that, for uncorrelated playback signals, it is possible to compensate for SRO. It is moreover shown that, the SRO estimates of embodiments are robust to the echo path changes. For the correlated playback signals, we show that, a local AEC filter is useful to decouple the filter convergence from the SRO estimation and achieve faster convergence of SRO.

According to some embodiments, multi-device AEC may, e.g., comprise one or more multi-channel Kalman filters, SRO estimation and resampling of far-end signals. For example, in a two device scenario, for both correlated and uncorrelated playback signals, embodiments successfully mitigate the divergence of the multi-channel Kalman filter in the presence of SRO for both echo-only and double-talk cases. In addition, for devices with correlated playback signals, an independent single channel AEC filter may, e.g., realize faster convergence of SRO estimation.

According to some embodiments, the synchronous solution is extended to a multi-device scenario. In particular, a scenario with two devices may, e.g., be considered (an extension to more than two devices is equally possible, and the scenario is treated as a two-channel system with SRO compensation. According to an embodiment, a (e.g., latest and more robust) dynamic weighted average coherence drift (DWACD) algorithm may, e.g., be employed to estimate the SRO. According to some embodiments, this estimate of the SRO may, e.g., then be used to resample the far-end signals before running the two-channel AEC.

It is shown that for uncorrelated playback signals, it is possible to compensate for SRO. Also, we show that, the SRO estimates are robust to the echo path changes. For the correlated playback signals, it is shown that, a local AEC filter may, e.g., be useful to decouple the filter convergence from the SRO estimation and achieve faster convergence of SRO.

Embodiments provide an extension of synchronous solutions to a multi-device scenario. According to embodiments, multi-device AEC may, e.g., be considered as multi-channel AEC that incorporates SRO compensation.

In some embodiments, a scenario with at least two devices with each device having at least one loudspeaker, and a presence of at least one microphone may, e.g., be considered. Configuring a multi-channel AEC with L channels with or without additional local AEC filter with at least 1 channel may, e.g., be described as

$$L = {\sum }_{n = 0}^{n = N - 1} {L}_{n} ,$$

wherein N is the number of devices and Ln is the number of loudspeakers in device n.

According to an embodiment, an estimation of at least one SRO with the combination of microphone and error signals and the far-end signals may, e.g., be determined. In an embodiment, a modification of one or more far-end signals with the use of one or more estimated SROs may, e.g., be conducted. According to an embodiment, the multi-channel AEC may, e.g., be run with the microphone signal and modified far-end signals.

Moreover, an apparatus for sampling rate offset compensation according to an embodiment is provided. The apparatus comprises a sample rate offset determiner configured for determining a sampling rate offset introduced by a device. Moreover, the apparatus comprises resampler configured for resampling, depending on the sampling rate offset, an initial reference signal to obtain a resampled reference signal. The sample rate offset determiner is configured to determine the sampling rate offset using a microphone signal or using a signal derived from the microphone signal.

Furthermore, a method for sampling rate offset compensation according to an embodiment is provided. The method comprises:
Determining a sampling rate offset introduced by a device.
Resampling, depending on the sampling rate offset, an initial reference signal to obtain a resampled reference signal.

Determining the sampling rate offset is conducted using a microphone signal or using a signal derived from the microphone signal.

Moreover, a computer program according to another embodiment for implementing the above-described method when being executed on a computer or signal processor is provided.

### BRIEF DESCRIPTION OF THE FIGURES

In the following, embodiments of the present invention are described in more detail with reference to the figures, in which:

FIG. 1 illustrates an apparatus for interference cancellation according to an embodiment.

FIGS. 2a and 2b illustrate a two-device AEC configured as a two-channel system with SRO compensation according to a first embodiment.

FIGS. 3a and 3b illustrate a two-device AEC configured as a two-channel system with independent single channel AEC and SRO compensation according to a second embodiment.

FIGS. 4a and 4b illustrate an echo return loss enhancement (ERLE) (dB) vs SRO(ppm) (a) and PESQ vs SRO(ppm) (b) for uncorrelated playback signals.

FIGS. 5a and 5b illustrate ERLE (dB) vs SRO(ppm)(a) and PESQ vs SRO(ppm)(b) for correlated playback signals.

FIG. 6 illustrates an estimated SRO (ppm) vs Time (sec) during an echo-only scenario with echo path changes for uncorrelated playback signals, wherein a true SRO is 100 ppm.

FIG. 7 illustrates an estimated SRO (ppm) vs Time (sec) during echo-only scenario with echo path changes for correlated playback signals, wherein a true SRO is 100 ppm.

FIG. 8 illustrates a teleconferencing scenario with two participating users at a location A, with another participating user at a location B, and with a further participating user at a location C.

FIG. 9 illustrates a block diagram depicting a primary device and two auxiliary devices.

FIG. 10 illustrates Multi-Channel AEC frameworks with Independent Filter Adaptation and Joint Filter Adaptation for solving the multi-device AEC problem in the presence of SRO according to an embodiment.

FIG. 11 illustrates Multi-Channel AEC frameworks with Joint Filter Adaptation for solving the multi-device AEC problem in the presence of SRO according to another embodiment.

FIG. 12 illustrates an apparatus for sampling rate offset compensation according to an embodiment.

FIG. 13 illustrates spatial audio reproduction using stereo loudspeakers.

FIG. 14 illustrates SRO Compensated spatial reproduction according to an embodiment.

FIG. 15A, 15B illustrate the difference plots of spatial cues such as ITD and IC with respect to no-SRO for the following conditions.

FIG. 16 illustrates plots for the estimated SRO for the first two minutes of the eight-minute file computed by averaging over seven different files.

FIG. 17 illustrates a MUSHRA test for three listeners.

### DETAILED DESCRIPTION OF THE FIGURES

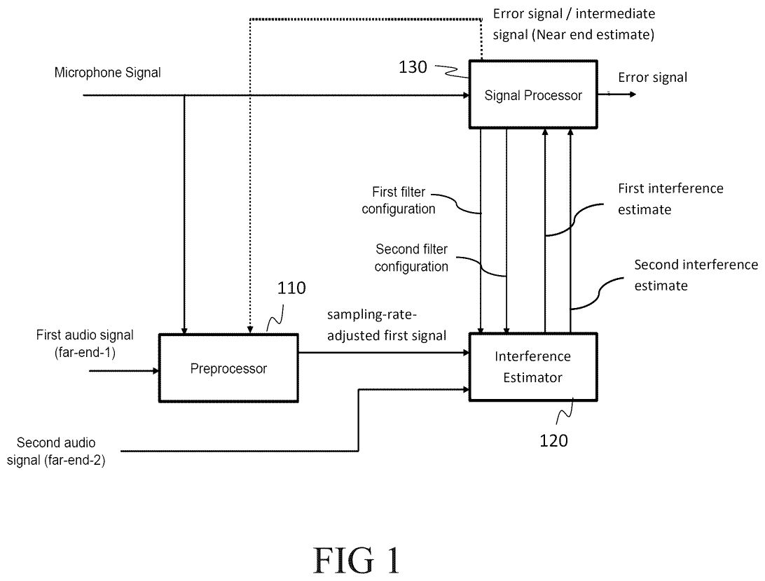

FIG. 1 illustrates an apparatus for interference cancellation according to an embodiment.

The apparatus comprises a preprocessor 110 configured for resampling a first audio signal to obtain a sampling-rate-adjusted first signal (a first resampled audio signal).

Moreover, the apparatus comprises an interference estimator 120 configured for estimating a first interference estimate depending on a first filter configuration and depending on the sampling-rate-adjusted first signal; and configured for estimating a second interference estimate depending on a second filter configuration and depending on a second audio signal.

Furthermore, the apparatus comprises a signal processor 130 configured for processing a microphone signal or an intermediate signal, being a signal derived from the microphone signal, depending on the first interference estimate and depending on the second interference estimate to obtain an error signal; configured for updating the first filter configuration and the second filter configuration depending on the error signal; and configured for outputting the error signal.

The preprocessor 110 is configured to resample the first audio signal depending on a sampling rate offset between a sampling rate of the microphone signal or of the intermediate signal or of the error signal, and a sampling rate of the first audio signal.

According to an embodiment, the first audio signal may, e.g., be a far-end signal of a first device. The microphone signal may, e.g., be a microphone signal of a second device being different from the first device.

In an embodiment, the second audio signal may, e.g., be a far-end signal of the second device.

According to an embodiment, the second audio signal may, e.g., be a far-end signal of a third device being different from the first device and being different from the second device.

In an embodiment, the preprocessor 110 may, e.g., be configured to determine the sampling rate offset using the first audio signal or information on the first audio signal and using another signal or information on said other signal, wherein said other signal may, e.g., be the microphone signal or may, e.g., be the intermediate or may, e.g., be the error signal. The preprocessor 110 may, e.g., be configured to resample the first audio signal using the sampling rate offset.

According to an embodiment, the signal processor 130 may, e.g., be configured to determine said other signal by determining the intermediate signal (E₁) by subtracting a signal indicating the second interference estimate from the microphone signal. The preprocessor 110 may, e.g., be configured to determine the sampling rate offset using the intermediate signal (E₁) or information on the intermediate signal (E₁). The signal processor 130 may, e.g., be configured to determine an error signal by subtracting a signal depending on the first interference estimate from the intermediate signal.

In an embodiment, the apparatus may, e.g., be configured to determine a filtered audio signal by filtering the second audio signal using a third filter configuration. The apparatus may, e.g., be configured to determine said other signal as a processed signal (E₀) by subtracting the filtered audio signal from the microphone signal to determine said other signal, and may, e.g., be configured to update the third filter configuration depending on the processed signal (E₀). The preprocessor 110 may, e.g., be configured to determine the sampling rate offset using the processed signal (E₀) or information on the processed signal (E₀).

According to an embodiment, the apparatus may, e.g., be configured to determine a filtered audio signal by filtering the second audio signal using a third filter configuration. The apparatus may, e.g., be configured to determine a processed signal (E₀) by subtracting the filtered audio signal from the microphone signal, and may, e.g., be configured to conduct, using beamformers, beamforming on the processed signal (E₀) to determine said other signal, and may, e.g., be configured to update the third filter configuration depending on the processed signal (E₀). The preprocessor 110 may, e.g., be configured to determine the sampling rate offset using outputs of the beamformers or information on the outputs of the beamformers.

In an embodiment, the apparatus may, e.g., be configured to determine said other signal by performing, using beamformers, beamforming on the microphone signal to determine said other signal. The preprocessor 110 may, e.g., be configured to determine the sampling rate offset using outputs of the beamformers or information on the output of the beamformers.

According to an embodiment, the preprocessor 110 may, e.g., be configured to determine the sampling rate offset,
by determining a processed phase function depending on the first audio signal or a signal derived from the first audio signal and depending on said other signal, and
by determining a maximum value of a generalized cross-correlation of the processed phase function, wherein the processed phase function may, e.g., be represented in a time domain, when the maximum value of the generalized cross-correlation is determined.

In an embodiment, the preprocessor 110 may, e.g., be configured to determine the processed phase function in a time-frequency domain. The preprocessor 110 may, e.g., be configured to transform the processed phase function from the time-frequency domain to the time domain.

According to an embodiment, the preprocessor 110 may, e.g., be configured to determine the sampling rate offset by conducting a golden search in an interval around the maximum value of the generalized cross-correlation of the processed phase function.

In an embodiment, the preprocessor 110 may, e.g., be configured to determine the sampling rate offset by determining coherence information depending on a cross-correlation of the first audio signal or a signal derived from the first audio signal and said other signal, depending on an autocorrelation of the first audio signal or said signal derived from the first audio signal, and depending on an autocorrelation of said other signal.

According to an embodiment, the coherence information may, e.g., be determined depending on the formula:

$$Γ ( k , l ) = \frac{{Φ}_{E {X}^{2}} ( k , l )}{\sqrt{{Φ}_{EE} ( k , l ) {Φ}_{{X}^{2} {X}^{2}} ( k , l )}}$$

wherein Γ(k, l) indicates the coherence information, wherein k indicates a time index of a time-frequency domain, wherein l indicates a frequency index of the time-frequency domain,
wherein ΦE X² (k, l) indicates the cross-correlation of the first audio signal or said signal derived from the first audio signal and said other signal,
wherein ΦX² X²(k, l) indicates the autocorrelation of the first audio signal or said signal derived from the first audio signal, and depending on said other signal,
wherein ΦEE(k, l) indicates the autocorrelation of said other signal.

In an embodiment, the coherence information may, e.g., be not determined if no activity is detected in the first audio signal or if no activity is detected in said other signal.

According to an embodiment, to determine the sampling rate offset,
the preprocessor 110 may, e.g., be configured to determine a coherence function as the coherence information,
the preprocessor 110 may, e.g., be configured to preprocess the coherence function to obtain a first phase function, and
the preprocessor 110 may, e.g., be configured to determine a smoothed phase function by autoregressive smoothing of the first phase function.

In an embodiment, the processed phase function may, e.g., be the smoothed phase function or depends on the smoothed phase function.

According to an embodiment, the interference estimator 120 may, e.g., be configured to employ Kalman filtering for estimating the first interference estimate and the second interference estimate.

In an embodiment, the interference estimator 120 may, e.g., be configured to employ partitioned block frequency domain Kalman filtering for estimating the first interference estimate and the second interference estimate.

According to an embodiment, the apparatus for interference cancellation may, e.g., be configured for conducting acoustic echo cancellation. The interference estimator 120 may, e.g., be configured as an echo estimator for estimating the first interference estimate, being a first echo estimate, depending on the first filter configuration and depending on the sampling-rate-adjusted first signal; and is configured for estimating the second interference estimate, being a second echo estimate, depending on the second filter configuration and depending on the second audio signal. The signal processor 130 may, e.g., be configured for processing the microphone signal or the intermediate signal, depending on the first echo estimate and depending on the second echo estimate to obtain the error signal.

In an embodiment, the apparatus may, e.g., be configured for conducting acoustic echo cancellation in a teleconferencing system.

In the following, particular embodiments are described.

At first, a problem formulation is provided.

Considering a room with ‘D’ devices comprising both a microphone and a loudspeaker. The microphone signal of p^{th} device y^{p}[n] is given by:

$${y}^{p} [ \frac{n}{{f}_{p}} ] = {\sum }_{d = 0}^{D - 1} {x}^{d} [ \frac{n}{{f}_{d}} - {τ}_{d} ] * {h}^{d , p} [ n ] + {z}^{p} [ \frac{n}{{f}_{p}} ] \qquad ( 1 )$$

where x^{d}[n] is the far-end signal played from the loudspeaker of the d^{th} device, h^{d,p}[n] is the echo impulse response (EIR) between the loudspeaker of the d^{th} device and the microphone of the p^{th} device, z^{p}[n] is the contribution of near-end speakers and noise at the microphone of p^{th} device and τ_{d} is the time delay between the microphone and reference signals. The sampling rate of p^{th} and d^{th} device are given by fₚ and f_{d} are respectively. It may, e.g., be assumed that the loudspeaker and the microphone of the same device has no SRO. However, there exists a SRO ϵ_{d} between the loudspeaker and microphone that doesn't belong to the same device. The relation between sampling rate fₚ and sampling rate f_{d} can be expressed, e.g., in terms of ϵd as:

$${f}_{d} = ( 1 + {ϵ}_{d} ) {f}_{p} \qquad ( 2 )$$

where |ϵ_{d}|<<1 is usually expressed in parts-per-million (ppm).

In an embodiment, ϵ_{d} may, e.g., indicate the sampling rate offset.

In another embodiment, ϵ_{d}·fₚ may, e.g., indicate the sampling rate offset.

Substituting (2) in (1), applying Taylor series approximation and applying short-time Fourier transform (STFT) with hop size Nₕ and window size N_{w}, (1) can be expressed in frequency domain in a simplified form as:

$${Y}^{p} ( k , l ) = {X}^{p} ( k , l ) {H}^{p , p} ( k , l ) + {Z}^{p} ( k , l ) + {\sum }_{d \neq p} {X}^{d} ( k , l ) {H}^{d , p} ( k , l ) {e}^{\frac{- j 2 π k}{{N}_{w}} ( \frac{{lN}_{h} ( {ϵ}_{d} - {τ}_{d} )}{{f}_{p}} )} \qquad ( 3 )$$

It may, e.g., be assumed that the time delay is zero i.e., the far-end signals and the microphone signal are perfectly synchronized.

A scenario with only two devices may, e.g., be considered, namely with a first device and a second device. It is however understood that the provided concepts can be applied to more than two devices. In the considered scenario, the microphone signal (Y¹) e.g., of the second device, can be written as:

$${Y}^{1} ( k , l ) = {X}^{1} ( k , l ) {H}^{1 , 1} ( k , l ) + {Z}^{1} ( k , l ) + {X}^{2} ( k , l ) {H}^{2 , 1} ( k , l ) {e}^{\frac{- j 2 π k}{{N}_{w}} ( \frac{{lN}_{h} ( {ϵ}_{2} )}{{f}_{1}} )} \qquad ( 4 )$$

The aim of multi-device AEC is to eliminate the echoes by modelling the EIR (H^{i,j}(k, l)) with the help of a linear finite impulse response (FIR) filter. However, the exponential term

$${e}^{\frac{- j 2 π k}{{N}_{w}} ( \frac{{lN}_{h} ( {ϵ}_{2} )}{{f}_{1}} )}$$

prevents the linear FIR filter to converge due to the fact that, from the perspective of microphone, the EIR (H^{2,1}(k, l)) appears to either shrink or expand over time. In order to solve this, the multi-device AEC problem may, e.g., be formulated as a multi-channel AEC problem which comprises of SRO estimation and resampling of the far-end signal X²(k, l). (e.g., the first audio signal).

It is also assumed that the device on which the AEC is running have access to all the far-end signals.

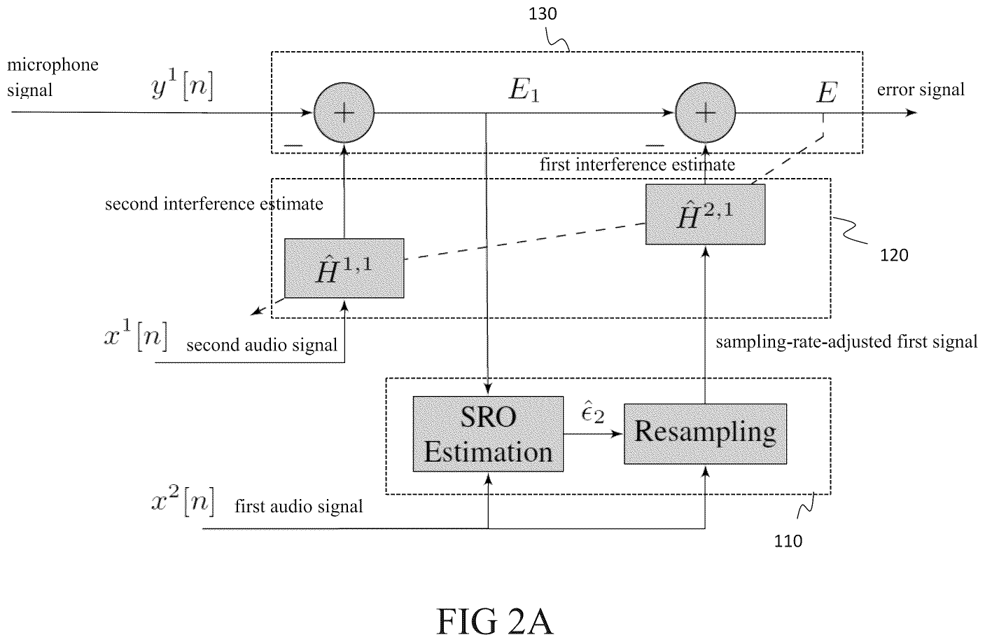

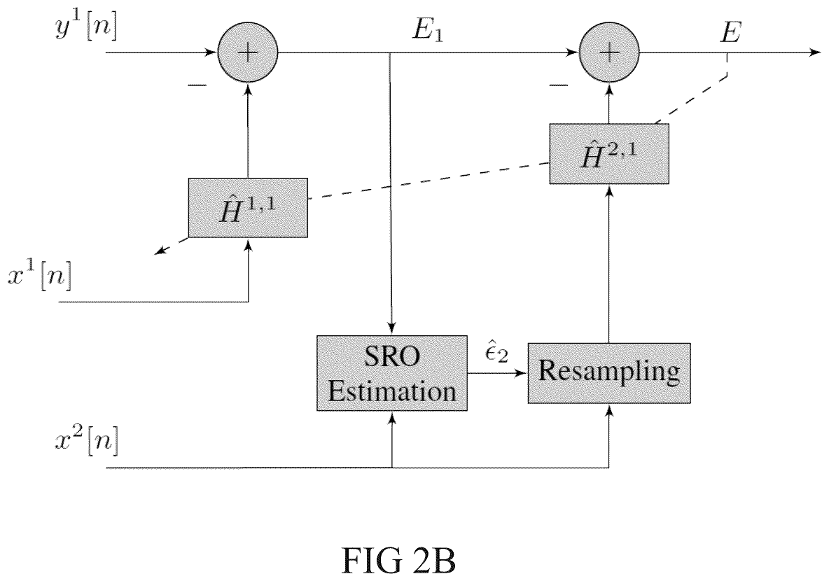

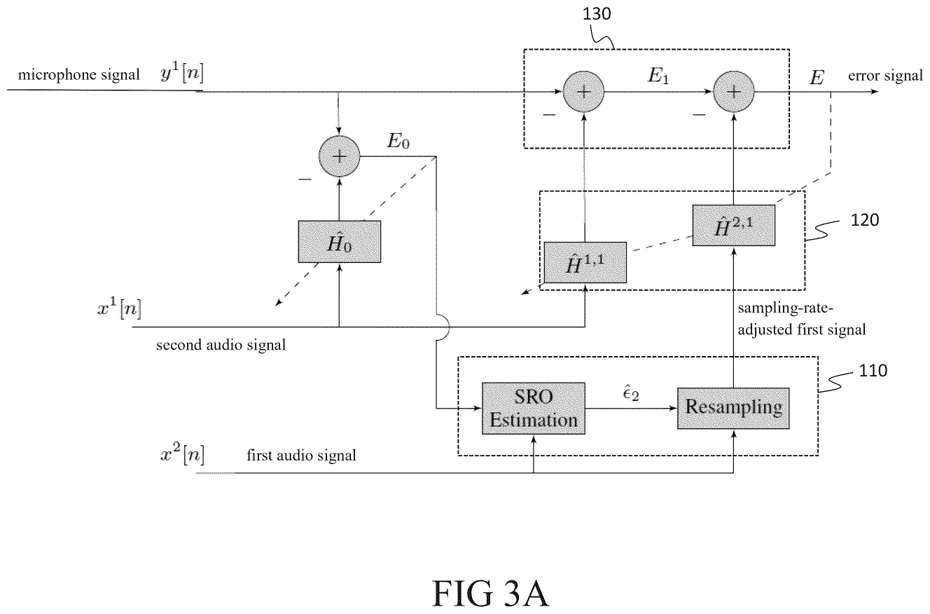

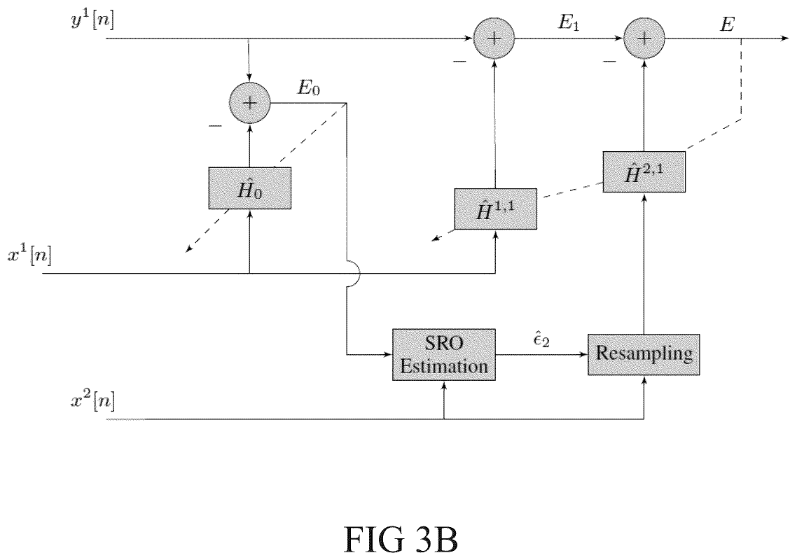

Embodiments according to two variants of a two-device AEC configured as a two-channel AEC system with SRO compensation are illustrated in FIG. 2a and FIG. 2b (variant 1) and in FIG. 3a and FIG. 3b (variant 2), respectively.

In particular, FIGS. 2a and 2b illustrate a two-device AEC configured as a two-channel system with SRO compensation according to a first embodiment (“variant 1”).

FIGS. 3a and 3b illustrate a two-device AEC configured as a two-channel system with independent single channel AEC and SRO compensation according to a second embodiment (“variant 2”).

In FIG. 2a, FIG. 2b, FIG. 3a and FIG. 3b:
x² [n] is a first audio signal with respect to the wording used when explaining FIG. 1. The same applies to X², which is also a first audio signal as described with reference to FIG. 1.
x¹[n] is a second audio signal with respect to the wording used when explaining FIG. 1. The same applies to X¹, which is also a second audio signal as described with reference to FIG. 1.

The SRO compensation (e.g., conducted by the preprocessor 110 of FIG. 1) comprises SRO estimation and resampling which is described at first below. The two-channel AEC filter is described in detail in the following below.

At first, SRO compensation according to particular embodiments is described.

In order to estimate the SRO, the DWACD algorithm described in [16] may, for example, be employed. Other algorithms for estimating the SRO may, alternatively be employed. The estimated SRO (\hat{ϵ}₂) may, for example, be obtained by first finding the peak βₘₐₓ that maximizes the generalized cross-correlation (GCC) p(β, l)=IFFT{P(k, l)} and by then performing a golden search (GS) in the interval [βₘₐₓ−0.5, βₘₐₓ+0.5]. It may, for example, be given by:

$${\hat{ϵ}}_{2} = - \frac{1}{{PN}_{h}} GS ( {β}_{max} - 0.5 , {β}_{max} + 0.5 ) \qquad ( 5 )$$

$${β}_{max} = arg {max}_{β} ( p ( β , l ) ) \qquad ( 6 )$$

P(k, l) may, for example, be obtained by auto-regressive smoothing of the phase function \tilde{P}(k, l). P(k, l) and the phase function \tilde{P}(k, l) may, for example, be given by:

$$P ( k , l ) = α \tilde{P} ( k , l - 1 ) + ( 1 - α ) \tilde{P} ( k , l ) \qquad ( 7 )$$

$$\tilde{P} ( k , l ) = Γ ( k , l + P ) {Γ}^{*} ( k , l ) \qquad ( 8 )$$

wherein Γ(k, l) may, e.g., be a coherence function obtained by cross power spectral density and auto power spectral densities. It may, for example, be given by:

$$Γ ( k , l ) = \frac{{Φ}_{E {X}^{2}} ( k , l )}{\sqrt{{Φ}_{EE} ( k , l ) {Φ}_{{X}^{2} {X}^{2}} ( k , l )}} \qquad ( 9 )$$

In the embodiment of variant 1, E is set to E₁, whereas, in the embodiment of variant 2, E is set to E₀. The coherence function Γ(k, l) is estimated only when activity is detected in both the signals X²(k, l) and E(k, l). A previously estimated SRO may, e.g., be used to resample the signal X²(k, l) before being used for the computation of the coherence function. Once the SRO (\hat{ϵ}₂) is estimated, the far-end signals may, e.g., be multiplied by the complex phase term

$$exp ( \frac{- j 2 π k}{{N}_{w}} ( \frac{{lN}_{h} {\hat{ϵ}}_{2}}{{f}_{p}} ) )$$

to approximate actual time-domain resampling [17]. Buffer management in both SRO estimation and resampling may, e.g., be employed to prevent the sample drift.

In the following, a two-channel AEC filter 120 according to a particular employed is described.

The two channel AEC filter 120 of such an embodiment may, e.g., be implemented by employing, e.g., partitioned block frequency domain Kalman filtering which may, e.g., be based on state-space architecture [1, 2, 3]. The filters themselves and each partition within the filters may, for example, be assumed to be mutually uncorrelated with zero mean.

Under such an assumption and the assumptions made in [3], the filter coefficient of i^{th} filter and b^{th} partition may, for example, be given by:

$${\hat{H}}_{b}^{i} [ l + 1 ] = A [ {\hat{H}}_{b}^{i} [ l ] + {K}_{b}^{i} [ l ] E [ l ] ] \qquad ( 10 )$$

where A is the transition factor, E[l] is the error signal and

$${K}_{b}^{i} [ l ]$$

is the Kalman gain of i^{th} filter and b^{th} partition and is given by:

$${K}_{b}^{i} [ l ] = {P}_{b}^{i} [ l ] {{( {X}_{b}^{i} )}^{H} [ l ] [ {\sum }_{b = 0}^{B - 1} {X}_{b}^{i} [ l ] {P}_{b}^{i} [ l ] {( {X}_{b}^{i} )}^{H} [ l ] + \frac{M}{V} {Ψ}_{ZZ} [ l ] ]}^{- 1} \qquad ( 11 )$$

Ψ_{ZZ}[l] is the covariance of the near-end spectrum Z[l].

$${P}_{b}^{i} [ l ]$$

is the covariance matrix of the coefficient error vector of i^{th} filter and b^{th} partition and is given by:

$${P}_{b}^{i} [ l ] = {A}^{2} [ {I}_{M} - {K}_{b}^{i} [ l - 1 ] {X}_{b}^{i} [ l - 1 ] {X}_{b}^{i} [ l - 1 ] ] {P}_{b}^{i} [ l - 1 ] + {Ψ}_{b , ΔΔ} [ l ] \qquad ( 12 )$$

where Ψ_{b,ΔΔ} is the covariance of the temporal variations of the acoustic transfer path.

In the following, experimental results are presented. The performance some particular embodiments is evaluated under both correlated case, where the devices are playing back the same signal and uncorrelated case, where the devices are playing back different signals. In echo-only scenario, ERLE is used to evaluate the performance whereas, Perceptual evaluation of speech quality (PESQ) [18] is used to evaluate the performance in the double-talk scenario by comparing the output of the proposed system with that of ground-truth near-end speech. For the evaluation, the above mentioned metrics were computed by averaging over 50 test files.

Considering the test signal generation, to generate the microphone signals, at first, far-end and near-end signals of duration 36 s at a sampling rate of 16 kHz from the training set si_tr_s of WSJ0 database [19] have been created. These files were normalized to −25 dBFS before convolving with simulated room impulse response (RIR)s [20]. The size of the room was chosen randomly with a uniform distribution between [5,5,3]m and [8,8,6]m. The reverberation time was set to a value between 0.2 s and 0.5 s with uniform probability. The device positions and near-end speaker positions were randomly chosen within a chosen room. However, it was ensured that they are at least 0.75 m away from the walls. Constant SROs in the range of −150 ppm and 150 ppm were simulated on echo signals using the STFT method proposed in [17] using segment length of 8192 samples. These SRO values were chosen since low SRO values are lot more common than the high SRO values [7, 21]. All the SRO simulated echo signals were added along with near end speech, if present, before adding with a gaussian noise at 40 dB SNR to simulate sensor noise.

The performance of two embodiments, namely the embodiment of variant 1 and the embodiment of variant 2 is compared with a system that assumes no SRO between the devices (no SRO), a system where SRO is not compensated (no compensation) and a system with oracle SRO compensation (oracle). For the echo-only scenario, ERLE is computed using the last 30 s whereas, for the double-talk scenario, PESQ is computed using the entire signal. The system operates with a zero delay, hence, SRO is estimated using two previous segments, each of length 8192 samples. The power spectral density is computed by averaging 9 successive frames and the smoothing parameter a is set to 0.95. The Kalman filters are implemented with 10 taps and FFT length of 512 samples. The value of the transition parameter (A) is set to 0.999 [1, 3].

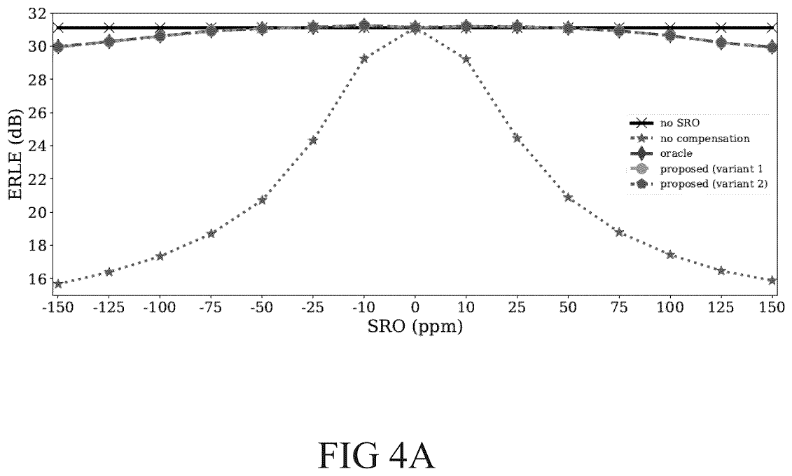

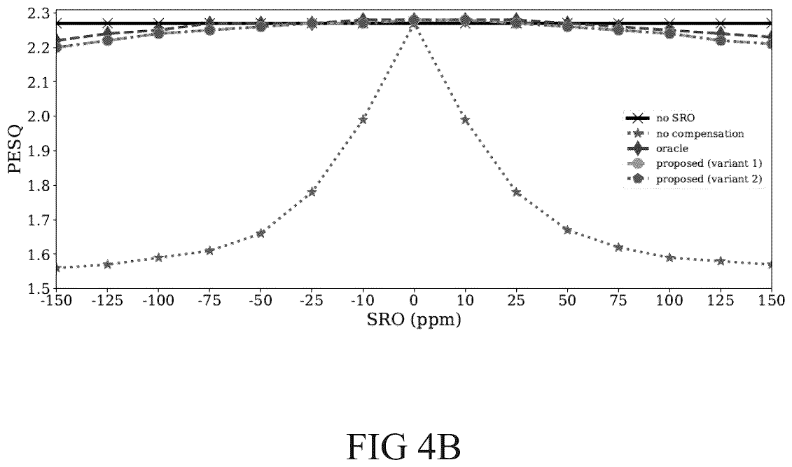

FIG. 4a and FIG. 4b illustrate an echo return loss enhancement (ERLE) (dB) vs SRO(ppm) (a) and PESQ vs SRO(ppm) (b) for uncorrelated playback signals. In particular, FIG. 4a evaluates the performance of the compared systems for echo-only scenario for uncorrelated far-end playback signals. When the SRO is uncompensated, the performance of the system drops since AEC filter Ĥ^{2,1} fails to converge to the true EIR H^{2,1}. When compensated for the SRO, both the variants of embodiments reach the performance of the system that assumes no SRO between the devices, especially at SRO values smaller than ±75 ppm. In addition, the performance of these variants matches that of oracle system. FIG. 4b evaluates performance of the compared systems for double-talk scenario for uncorrelated playback signals. The performance is similar to echo-only scenario.

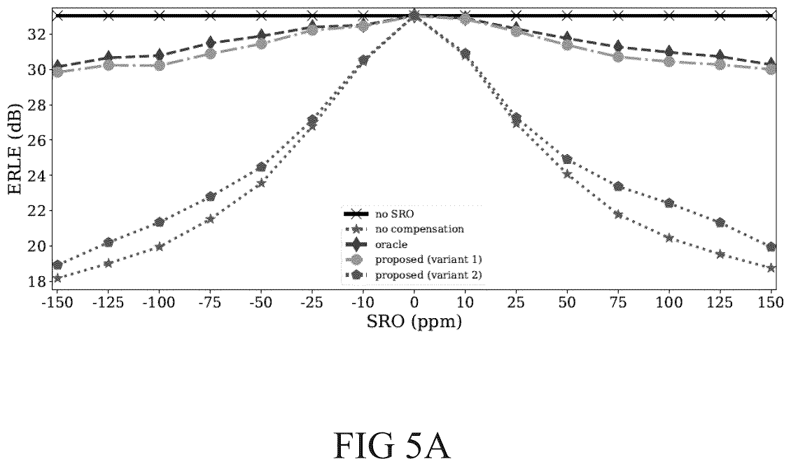

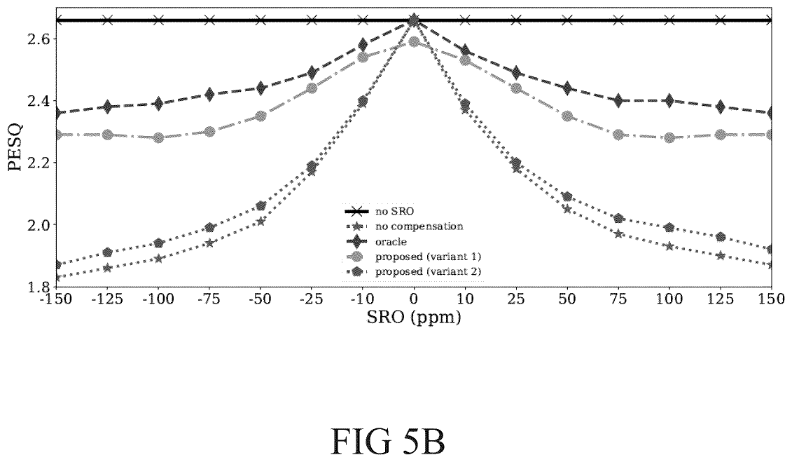

The estimated SROs is robust and is very close to the true SRO. FIG. 5a and FIG. 5b illustrate ERLE (dB) vs SRO(ppm)(a) and PESQ vs SRO(ppm)(b) for correlated playback signals. In particular, FIG. 5a and FIG. 5b evaluates the performance of the compare systems for echo-only and double-talk scenario respectively for correlated playback signals. Although the two-channel AEC suffers from non-uniqueness problem in case of correlated playback signals [22, 23], for the conducted simulation, where the sources are fixed, the performance of two-channel AEC and performance of single-channel AEC system are identical. This is due to the fact, that they both converge to the same solution. When the SRO is uncompensated, the performance of the system drops due to the divergence of the two-channel AEC. For variant 1, the filter convergence and SRO estimation impact each other leading to slow convergence of SRO. Hence, the performance of variant 1 is similar to system with no compensation in both echo-only and double-talk scenarios. Hence, for variant 2, a local filter Ĥ₀ is employed in order to decouple the filter convergence and SRO estimation. This decoupling helps the estimated SRO to converge faster to the true SRO. In the echo-only scenario, the performance of the embodiment of variant 2 and the system using oracle SRO has quite similar performance.

Considering SRO estimation in presence of echo path change, the robustness of SRO estimation in echo-only scenario for both uncorrelated and correlated playback signals is evaluated. 3 echo path changes on a signal with duration 60 s are simulated. At 15 s, only the position of device 2 is changed thus affecting the EIR H^{2,1}. At 30 s, only the microphone of the device 1 is changed affecting the EIR H^{1,1}. At 45 s, both the microphone of the device 1 and the device 2 are simultaneously changed affecting the EIR H^{2,1} and H^{1,1} simultaneously.

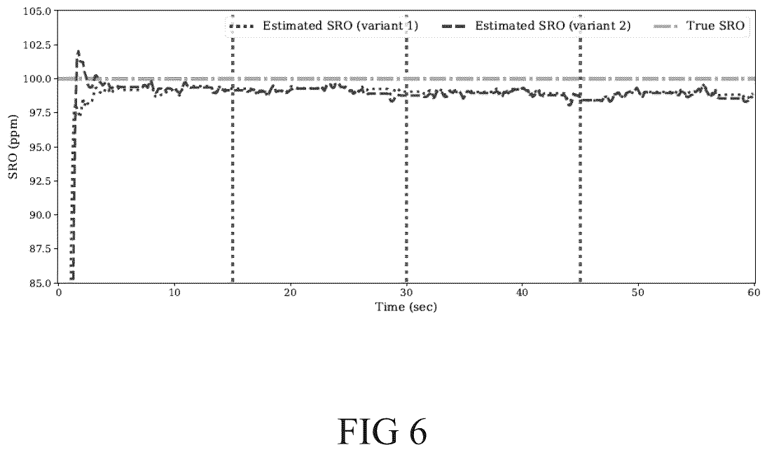

FIG. 6 compares the estimated SRO for the embodiments of the two variants with the true SRO for uncorrelated playback signals. In particular, FIG. 6 illustrates an estimated SRO (ppm) vs Time (sec) during an echo-only scenario with echo path changes for uncorrelated playback signals, wherein a true SRO is 100 ppm. The estimated SRO for both the variants quickly converges to the true SRO and is robust to all the simulated echo path changes.

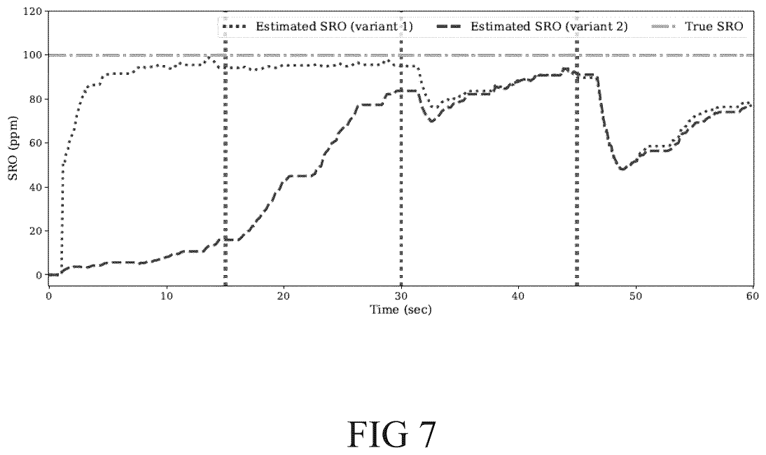

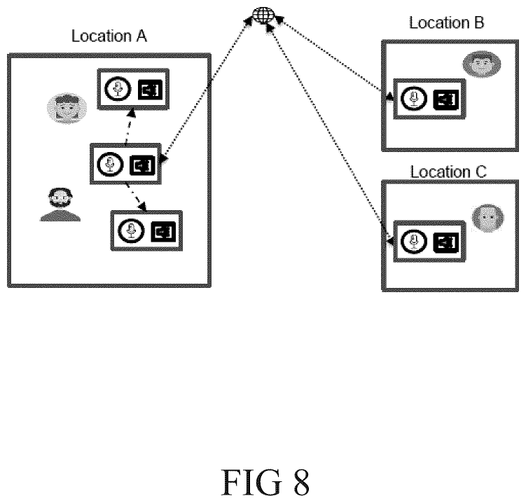

FIG. 7 compares the estimated SRO for the embodiments of the two variants with the true SRO for correlated playback signals. In particular, FIG. 7 illustrates an estimated SRO (ppm) vs Time (sec) during echo-only scenario with echo path changes for correlated playback signals, wherein a true SRO is 100 ppm.

In the embodiment of variant 1, the filter convergence and SRO estimation affect each other leading to a slower convergence of SRO estimation. It has been found that a decoupling of the filter convergence from the SRO estimation as done in the variant 2 is useful for a faster convergence of the SRO estimation. Once the SRO estimation converges, SRO estimation of both the variants of the system perform similarly. In addition, it is observed that a change in EIR H^{2,1} has no impact on the SRO estimation, whereas, change in EIR H^{1,1} leads to a small drop in the estimated SRO. A simultaneous change in the EIR H^{2,1} and H^{1,1} simultaneously results in a drop in the estimated SRO.

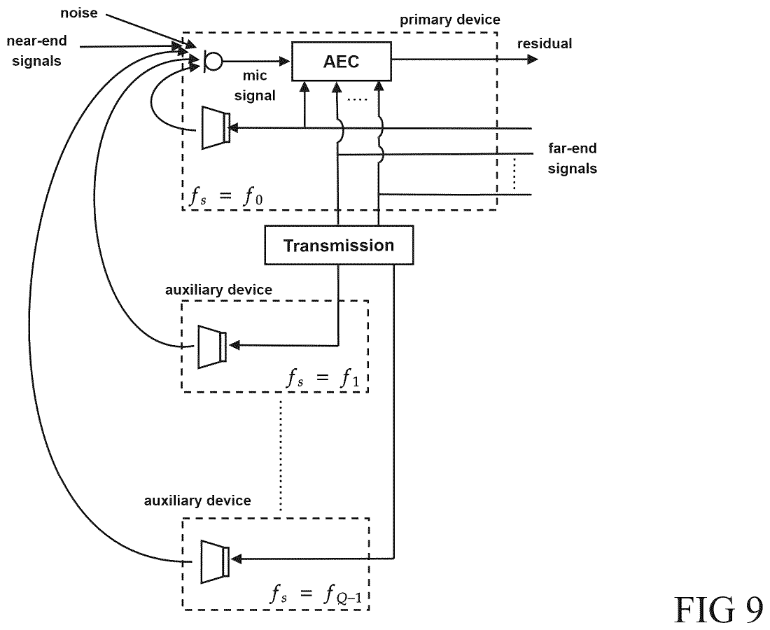

FIG. 9 illustrates a block diagram depicting a primary device and two auxiliary devices.

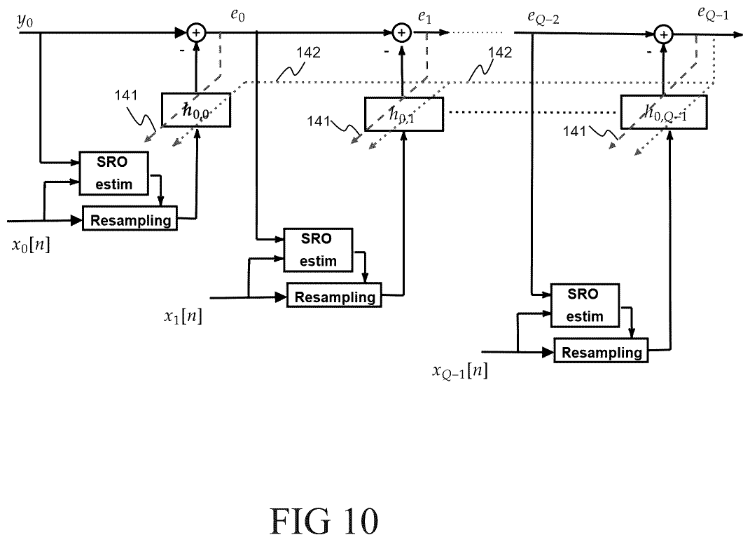

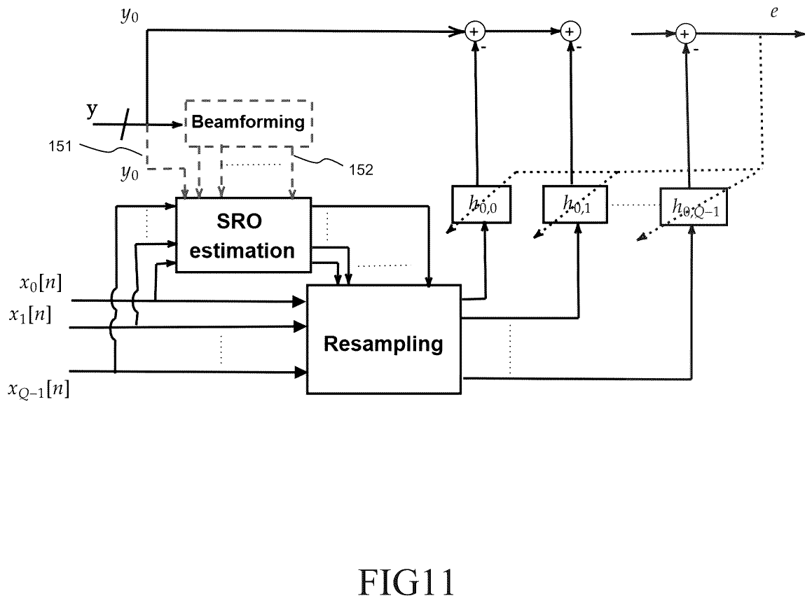

FIG. 10 illustrates Multi-Channel AEC frameworks with Independent Filter Adaptation (MC-IFA) (reference sign 141) and Joint Filter Adaptation (MC-JFA) (reference sign 142) for solving the multi-device AEC problem in the presence of SRO according to an embodiment. MC-IFA adapts filters using intermediate error signals, while MC-JFA uses a combined global error signal to jointly update all filters.

FIG. 11 illustrates Multi-Channel AEC frameworks with Joint Filter Adaptation (MCJFA) for solving the multi-device AEC problem in the presence of SRO according to another embodiment. In the variant MC-JFA-MS (reference sign 151), SRO is estimated directly from the microphone signal. In the other variant MC-JFA-SF (reference sign 152), a spatial filter is used to isolate relevant signals for improved SRO estimation.

In the following, embodiments of another aspect are described. These embodiments relate to multi-device spatial audio reproduction in the presence of sample rate offsets and relate to audio-domain compensation specifically for spatial audio rendering.

Such embodiments take the perceptual effects of sample rate offset in a loudspeaker setup, e.g., a stereo loudspeaker setup, into account.

In some embodiments, an audio-domain SRO compensation method is provided that applies spatial filtering (for details on spatial filtering variants, see [37]) to isolate loudspeaker contributions. The spatially filtered loudspeaker contributions may, e.g., then be used along with playback signals to estimate the SROs using the dynamic weighted average coherence drift (DWACD) algorithm (see [16]).

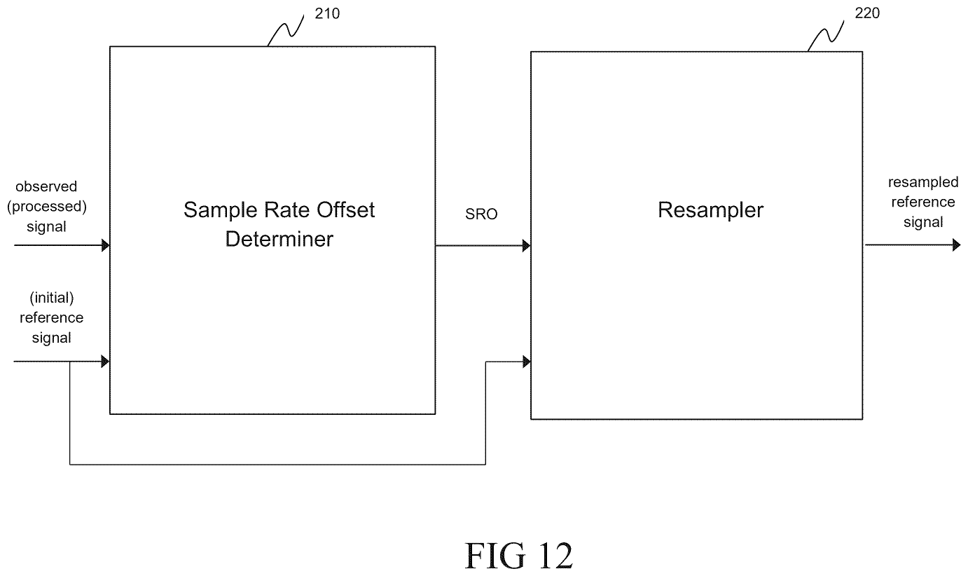

FIG. 12 illustrates an apparatus for sampling rate offset compensation according to an embodiment.

The apparatus comprises a sample rate offset determiner 210 configured for determining a sampling rate offset introduced by a device.

Moreover, the apparatus comprises resampler 220 configured for resampling, depending on the sampling rate offset, an (initial) reference signal to obtain a resampled reference signal.

The sample rate offset determiner 210 is configured to determine the sampling rate offset using a microphone signal or using a signal derived from the microphone signal.

According to an embodiment, the device introducing the sampling rate offset may, e.g., be a loudspeaker. The microphone signal used by the sample rate offset determiner 210 to determine the sampling rate offset may, e.g., be recorded by a microphone which records sound waves emitted by the loudspeaker. The apparatus may, e.g., be configured to provide the resampled reference signal or a signal derived from the resampled reference signal to the loudspeaker.

In an embodiment, the loudspeaker may, e.g., be a first loudspeaker. The sampling rate offset determined by the sample rate offset determiner 210 may, e.g., be a first sampling rate offset. The resampled reference signal may, e.g., be a first resampled reference signal for being provided to the first loudspeaker. The sample rate offset determiner 210 may, e.g., be configured for determining a second sampling rate offset introduced by a second loudspeaker. The resampler 220 may, e.g., be configured for resampling, depending on the second sampling rate offset, the initial reference signal to obtain a second resampled reference signal. The apparatus may, e.g., be configured to provide the second resampled reference signal or a signal derived from the second resampled reference signal to the second loudspeaker.

According to an embodiment, the first sampling rate offset introduced by the first loudspeaker may, e.g., be different from the second sampling rate offset introduced by the second loudspeaker.

In the following, particular embodiments for audio-domain SRO compensation are provided, which employ spatial filtering to isolate loudspeaker contributions. These filtered signals, along with the original playback signal, are used to estimate the SROs. The effect of SROs are then compensated before spatial rendering. The effect of SROs is compensated before spatial rendering, thus requiring no explicit clock synchronization.

At first, spatial reproduction amid SROs is considered.

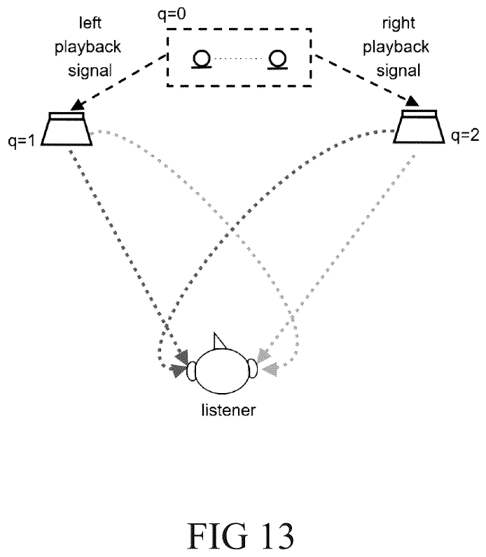

FIG. 13 illustrates spatial audio reproduction using stereo loudspeakers. In particular, in FIG. 13, a room is considered with three devices and a listener. Without loss of generality, the first device is considered as a primary device (q=0) that transmits playback signals at a sampling rate fₛ to auxiliary devices (q=1, q=2), each containing a single loudspeaker. In addition, it is assumed that the primary device only contains a microphone array. Under the above assumptions, the binaural signal at the ears of the listener bi where i∈{L, R} can be described as

$${b}_{i} [ n ] = {{\sum }^{2}}_{q = 1} {h}_{i , q} [ n ] * {x}_{q} [ n ] , \qquad ( 13 )$$

where n is the sample index, q is the index of auxiliary device, x_{q}[n] is the playback signal, h_{i,q}[n] are the acoustic impulse responses (AIR) between the loudspeakers of the q-th auxiliary device and the ears of the listener. Assuming that the playback signals are synchronized, e.g., the auxiliary devices play at the same sampling rate fₛ, (13) can be described in the time-frequency domain as

$${B}_{i} [ k , l ] = {\sum }_{q = 1}^{2} {H}_{i , q} [ k , l ] {X}_{q} [ k , l ] , \qquad ( 14 )$$

where Bᵢ[k,l], X_{q}[k, l] and H_{i,q}[k, l] with frequency index k and frame index l represent the time-frequency domain counter parts of bᵢ[n], x_{q}[n] and h_{i,q}[n] respectively. However, when the sampling rate of the auxiliary devices differ due to the presence of SROs, the playback signals are not synchronized.

In such a scenario, the binaural signal at the ears of the listener in the frequency domain with sufficiently large window size N_{w} and hop size Nₕ can be written as [38]:

$${B}_{i} [ k , l ] = {\sum }_{q = 1}^{2} {H}_{i , q} [ k , l ] {Λ}_{q} [ k , l ] {X}_{q} [ k , l ] , \\ where \\ {Λ}_{q} [ k , l ] = exp ( \frac{- j 2 π k}{{N}_{w}} ( \frac{l {N}_{h} {ϵ}_{q}}{{f}_{s}} ) ) , \qquad ( 15 )$$

ϵ_{q} is the SRO defined in parts-per-million (ppm), and it should be noted that (15) holds only if

$$\frac{l {N}_{h} {ϵ}_{q}}{{f}_{s}} ≪ {N}_{w}$$

(see [39]). The SRO term explains the difference between the sampling rate of the playback signals fₛ and the playback sampling rate f_{q} and is given by

$${f}_{q} = ( 1 + {ϵ}_{q} ) {f}_{s} . \qquad ( 16 )$$

In the following, ϵ_{q} is assumed to be constant, and the effect of delay, coding, and frame errors that commonly occur during the transmission of playback signals from the primary device to the auxiliary devices is ignored.

In this study, we evaluate the effect of Λ_{q}[k, l] on spatial perception from the listener's perspective. In addition, we propose a solution to nullify the effect of Λ_{q}[k, l]. This involves first estimating the SRO ϵ_{q} and resampling the playback signal X_{q}[k, l] to X̅_{q}[k, l] where X̅q[k, l]=X_{q}[k, l]Λ̅_{q}[k, l] such that

$${\overline{Λ}}_{q} [ k , l ] {\overline{Λ}}_{q} [ k , l ] = 1 and {\overline{Λ}}_{q} [ k , l ] = exp ( \frac{- j 2 π k}{{N}_{w}} ( \frac{l {N}_{h} {ϵ}_{q}}{{f}_{s}} ) ) .$$

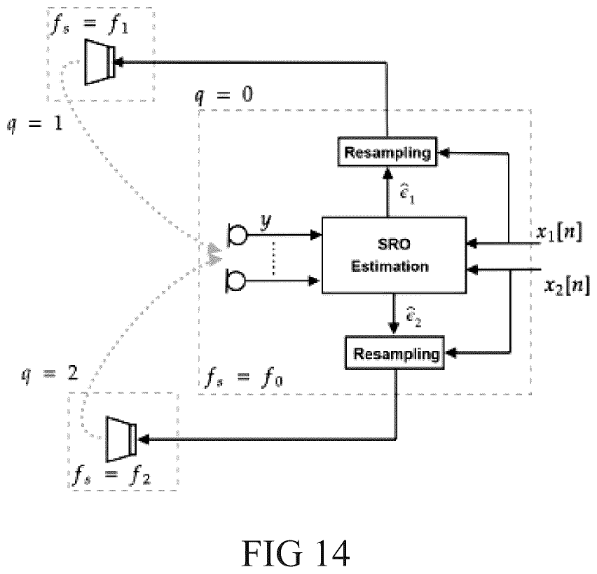

In the following, SRO compensated spatial reproduction according to particular embodiments is described. An SRO compensated spatial reproduction system according to a particular embodiment is shown in FIG. 14. Since the setup of FIG. 14, the primary device has a microphone array, it is responsible for estimating the SRO and resampling before transmitting it to the auxiliary devices. The primary device uses a spatial filter (regarding spatial filters, see, e.g., [37] and [40]) to extract each individual contribution of the loudspeaker signals. The spatial filter output and the playback signal are then used to estimate the SRO. The playback is then resampled to compensate for the effect of SRO before transmission to the auxiliary devices.

With respect to a signal model, the microphone signals of the primary device can be defined as

$${y}_{0 , m} [ n {T}_{0} ] = {{\sum }_{q = 1}}^{2} {h}_{0 , q , m} [ n {T}_{0} ] * {x}_{q} [ n {T}_{0} ] + {v}_{0 , m} [ n {T}_{0} ] , \qquad ( 17 )$$

where n is the sample index,

$${T}_{0} = \frac{1}{{f}_{0}}$$

is the sampling period of the primary device, m is the microphone index, q is the index of auxiliary device, x_{q}[nT₀] is the contribution of playback signal, v_{0,m}[nT₀] is the contribution of sensor noise, h_{0,q,m}[nT₀] is the acoustic impulse response (AIR) between the loudspeaker of the q^{th} auxiliary device and the microphone of the primary device. Since the loudspeaker of q^{th} auxiliary device converts the digital signal x_{q}[nTₛ] that is transmitted from primary device into its analog counterpart at a sampling rate of f_{q} and the microphone of the primary device converts the analog signal back to a digital signal at a sampling rate of f₀, we can define the relation between fₛ and f_{q} in terms of SRO between the devices ϵ_{q} and ϵ₀ as

$${f}_{0} = ( 1 + {ϵ}_{q} ) ( 1 + {ϵ}_{0} ) {f}_{s} , \qquad ( 18 )$$

where |ϵ_{q}|<<1 and |ϵ₀|<<1 are usually expressed in ppm. Since the terms ϵ_{q} and ϵ₀ are very small, the term ϵ_{q}*ϵ₀ can be ignored. This further simplifies (18) as

$${f}_{0} = ( 1 + {ϵ}_{q} + {ϵ}_{0} ) {f}_{s} = ( 1 + {\overline{ϵ}}_{q} ) {f}_{s} . \qquad ( 19 )$$

Substituting (19) in (17), applying Taylor series approximation to the term xq

$${x}_{q} [ \frac{n}{( 1 + {\overline{ϵ}}_{q} ) {f}_{s}} ]$$

[38], (17) can be approximated in time-frequency domain with sufficiently long window size N_{w} and hop size Nₕ as

$${Y}_{0 , m} [ k , l ] = {\sum }_{q = 1}^{2} {H}_{0 , q , m} [ k , l ] {Λ}_{q} [ k , l ] {X}_{q} [ k , l ] + {V}_{0 , m} [ k , l ] , \\ where \\ {Λ}_{q} [ k , l ] = exp ( \frac{- j 2 π k}{{N}_{w}} ( \frac{l {N}_{h} {\overline{ϵ}}_{q}}{{f}_{s}} ) ) , \qquad ( 20 )$$

X_{q}[k, l], H_{0,q,m}[k, l] and V_{0,m}[k, l] with frequency index k and frame index l are the frequency-domain representation of x_{q}[nTₛ], h_{0,q,m}[nT₀], and v_{0,m}[nT₀] respectively. Similarly to (15), (20) also holds only if the condition

$$\frac{l {N}_{h} {\overline{ϵ}}_{q}}{{f}_{s}} ≪ {N}_{w}$$

is satisfied [39]. Since the primary device estimates the term ϵ̅_{q}, in the current work, we assume that ϵ₀ is known a-priori to estimate ϵ_{q} from ϵ̅_{q}.

In the following, playback signal-assisted spatial filtering according to a particular embodiment is described.

In vector notation, (20) can be written as

$$y = H Λ x + v , \qquad ( 21 )$$

where the microphone signal y, playback signal x, acoustic transfer function (ATF) H, SRO contribution Λ and sensor noise v are defined as

$$y = {[ {Y}_{0 , 0} [ k , l ] , {Y}_{0 , 1} [ k , l ] … {Y}_{0 , M - 1} [ k , l ] ]}^{T} ∈ {R}^{M \times 1} , \qquad ( 22 )$$

$$x = {[ {X}_{1} [ k , l ] , {X}_{2} [ k , l ] ]}^{T} ∈ {R}^{2 \times 1} , \qquad ( 23 )$$

$$H = [ {h}_{1 , 0} , {h}_{2 , 0} ] ∈ {R}^{M \times 2} , \qquad ( 24 )$$

$$Λ = diag [ {Λ}_{1} [ k , l ] , {Λ}_{2} [ k , l ] ] ∈ {R}^{2 \times 2} , \qquad ( 25 )$$

$$v = {[ {V}_{0 , 0} [ l , k ] , {V}_{0 , 1} [ k , l ] … {V}_{0 , M - 1} [ k , l ] ]}^{T} ∈ {R}^{M \times 1} , \qquad ( 26 )$$

$$where$$

$${h}_{0 , 1} = {[ {H}_{0 , 0 , q} [ k , l ] , {H}_{0 , 1 , q} [ k , l ] … {H}_{0 , m , q} [ k , l ] ]}^{T} .$$

Since we are interested in robust estimation of ϵ̅₁ and ϵ̅₂, we need to extract individual terms h_{0,1} Λ₁[k, l] X₁[k, l] and h_{0,2} Λ₂[k, l] X₂ [k, l] respectively from the microphone signal y. In the current study, this is achieved by employing the well-known linearly constrained minimum variance (LCMV) beamformer [37] to extract individual contributions from the microphone signal. The output of the beamformer \hat{Z}_{q}(k, l) can be described as

$${\hat{Z}}_{q} [ k , l ] = {w}_{q}^{H} [ k , l ] y . \qquad ( 27 )$$

where w_{q}[k, l] is the beamformer weights computed by treating q^{th} loudspeaker as “source of interest” and another loudspeaker as interferer and superscript (·)^{H} denotes the hermitian. Ideally,

$${\hat{Z}}_{q} [ k , l ] \approx {h}_{0 , q} {Λ}_{q} [ k , l ] {X}_{q} [ k , l ] + v .$$

The LCMV beamformer weights w_{q}[k, l] is computed by solving the optimization problem [41]

$${w}_{q} ( k , l ) = arg {min}_{{w}_{q}} {w}_{q}^{H} {Φ}_{υ} {w}_{q} \qquad ( 28 )$$

$$subject to {w}_{q}^{H} A [ k , l ] = {g}_{q} ,$$

where the gain g_{q} is the q^{th} column of identity matrix I∈ [symbol] ^{2×2},

$$A [ k , l ] = [ {a}_{0} , {a}_{1} … {a}_{q} ] ∈ {R}^{M \times 2}$$

is the relative transfer function (RTF) matrix,

$${a}_{q} = \frac{{h}_{0 , q}}{{H}_{0 , q , 0}}$$

is the RTF vector under the assumption that 0^{th} microphone is the reference microphone.

The solution to the above optimization problem is given by

$${w}_{q} [ k , l ] = {Φ}_{υ}^{- 1} {A [ k , l ] [ {A}^{H} [ k , l ] {Φ}_{υ}^{- 1} A [ k , l ] ]}^{- 1} {g}_{q} , \qquad ( 29 )$$

where Φᵥ is the noise power spectral density (PSD) matrix. The inverse term in (29) exists only if it satisfies the following criteria [37], [40], [42]: i) Φᵥ is full-rank, ii) A[k, l] has linearly independent columns. In the implementation, Φᵥ may, e.g., be set as: Φ_{c}=I, which satisfies the first criterion. However, since it cannot be guaranteed that the second criterion is fulfilled, a regularization method may, e.g., be employed, e.g., diagonal loading where a small term α I, is added to the inverse term [42], [43] to ensure numerical stability.

With the above, the solution to the LCMV beamformer is given by

$${w}_{q} [ k , l ] = {A [ k , l ] [ {A}^{H} [ k , l ] A [ k , l ] + α I ]}^{- 1} {g}_{q} , \qquad ( 30 )$$

where α is a small constant.

Estimation of RTF matrix A[k,l] is a fundamental problem. There exist many methods to estimate RTF, among them, minimum distortion-based estimator [44] and subspace-based estimators [45] can be considered as state-of-the-art estimators. These estimators work well for one source; however, in case of multiple sources, these estimators require periods where only one source is active. In [46], a time-varying RTF estimator per time-frequency bin corresponding to the dominant source at that bin is described.

In a particular embodiment, the an oracle RTF may, e.g., be employed for RTF estimation, which may, e.g., be computed as

$${a}_{q} [ k , l ] = \frac{{\overline{Φ}}_{q}}{{e}^{T} {\overline{Φ}}_{q}} , \qquad ( 31 )$$

where e=[1, 0, . . . 0]^{T} is the selection vector, Φ̅ is the PSD matrix defined as

$${\overline{Φ}}_{q} = E \{ {z}_{q} {X}_{q}^{*} \} , \qquad ( 32 )$$

where (·)* denotes the complex conjugate, z̅_{q} is the microphone signal containing only the playback signal X_{q}.

In the following, SRO estimation according to a particular embodiment is described.

To estimate the SRO, the DWACD algorithm described in [16] may, for example, be employed. Given the input signal \hat{Z}_{q}[k, l] and the reference signal X_{q}[k, l], the SRO estimation relies on first computing the complex coherence function Γ[k, l], which is given by

$$Γ [ k , l ] = \frac{{Φ}_{{\hat{Z}}_{q} {X}_{q}} [ k , l ]}{\sqrt{{Φ}_{{\hat{Z}}_{q} {\hat{Z}}_{q}} [ k , l ] {Φ}_{{X}_{q} {X}_{q}} [ k , l ]}} , \qquad ( 33 )$$

$$where$$

$${Φ}_{{\hat{Z}}_{q} {X}_{q}} , {Φ}_{{\hat{Z}}_{q} {\hat{Z}}_{q}} and {Φ}_{{X}_{q} {X}_{q}}$$

are the cross and auto PSDs, respectively.

The phase function \tilde{P}[k, l] is computed by the complex conjugated product of two consecutive complex coherence functions with a temporal distance of L. It is given by

$$\tilde{P} [ k , l ] = Γ [ k , l + L ] {Γ}^{*} [ k , l ] . \qquad ( 34 )$$

The temporally averaged phase function P[k, l] and the generalized cross-correlation (GCC) p(β, l) are given by

$$P [ k , l ] = α P [ k , l - 1 ] + ( 1 - α ) \tilde{P} [ k , l ] , \qquad ( 35 )$$

$$p [ β , l ] = IDFT \{ P [ k , l ] \} , \qquad ( 36 )$$

where α is the smoothing factor, β is the time-lag and IDFT is the inverse DFT. The estimated SRO Ê̅_{q} is obtained by first finding the integer time-lag βₘₐₓ that maximizes the GCC

$${{ϵ}^{\hat{\_}}}_{q} [ l ] = - \frac{1}{L {N}_{h}} {β}_{max} = - \frac{1}{L {N}_{h}} arg {max}_{β} \vert p [ β , l ] \vert . \qquad ( 37 )$$

Then, an SRO estimate is obtained by determining the non-integer time-lag by performing a golden search in the interval given by [βmax−0.5, βmax+0.5]. The complex coherence function Γ[k, l] is estimated only when speech activity is detected in both signals \hat{Z}_{q}[k, l] and X_{q}[k, l]. In this study, we used the energy-based VAD to detect speech activity. To avoid temporal fluctuations in the estimated SRO, we apply temporal smoothing on the estimated SRO.

In the following, experimental results are provided, and the effect of applying the compensation method is evaluated in a subjective listening test. A particular embodiment is evaluated using objective metrics and subjective listening tests and demonstrates that the proposed method is useful in preserving the spatial cues and minimizing the perceptual degradation. The results of these tests as well as objective metrics demonstrate that the proposed method minimizes the perceptual degradation introduced by SROs by preserving the spatial cues.

For the evaluation, a room of size [7, 7, 6]m with an RT60 value of 0.3 s is considered. Stereo loudspeakers were placed at [2.2, 3.4, 1.8]m and at [5.2, 3.5, 2.1]m respectively. The primary device consisted of a circular microphone array with four microphones centered at [3.75, 3.35, 2.0]m and radius 10 cm.

With these parameters, the microphone signals were generated at a sampling rate of 16 kHz using Pyroomacoustics (see [47]). The following three SRO configurations (ϵ₁, ϵ₂) have been simulated: (10, −10) ppm, (10, −50) ppm and (10, −100) ppm on the microphone signal using the STFT method proposed in [39] using segment length of 8192 samples [16].

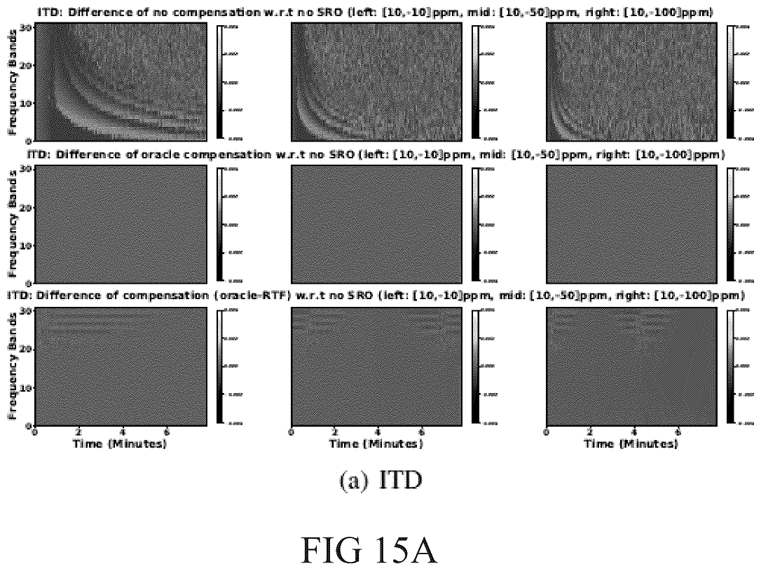

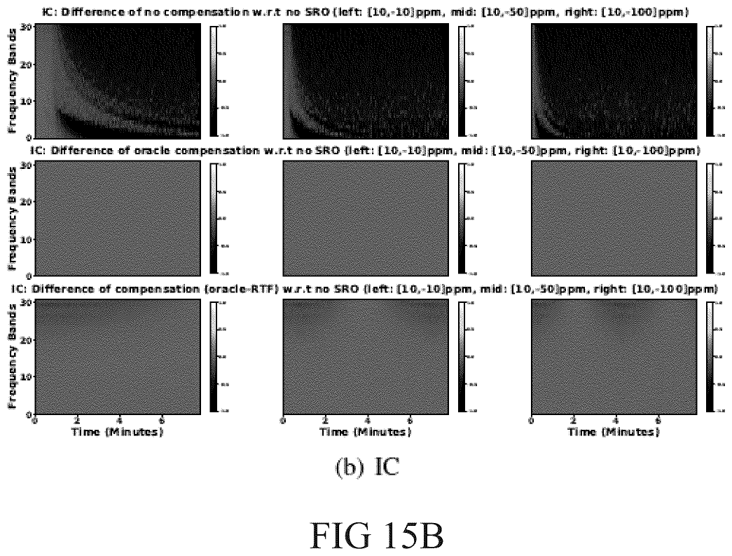

FIG. 15A, 15B depict the difference plots of spatial cues such as ITD and IC with respect to no-SRO for the following conditions: no compensation, oracle compensation, oracle-RTF-based compensation. In particular, FIG. 15A, 15B illustrate difference plots of ITD and IC with respect to no-SRO for the conditions (top: no compensation, middle: oracle compensation, bottom: oracle-RTF-based compensation) at three different SRO configurations (left: [10, −10] ppm, mid: [10, −50] ppm, right: [10, 100] ppm). Spatial cues were computed using the model presented in [48] implemented in the auditory modeling toolbox [49] for a synthetic stereo signal of length 8 minutes containing the same Gaussian white-noise in both channels. When the SRO is not compensated, it can be seen that the coherence reaches the value of zero (i.e., the coherence decreases) faster at higher SROs compared to lower SROs. Also, the model prediction of ITD is affected by the SRO. When the SRO is perfectly compensated, it can be seen that the effect of SRO on spatial cues is perfectly compensated. Oracle-RTF based compensation shows that the effect of SRO on the spatial cues can be compensated, especially at low and mid frequencies. At higher frequencies, the effect of the SRO on the spatial cues is minimized but not perfectly compensated.

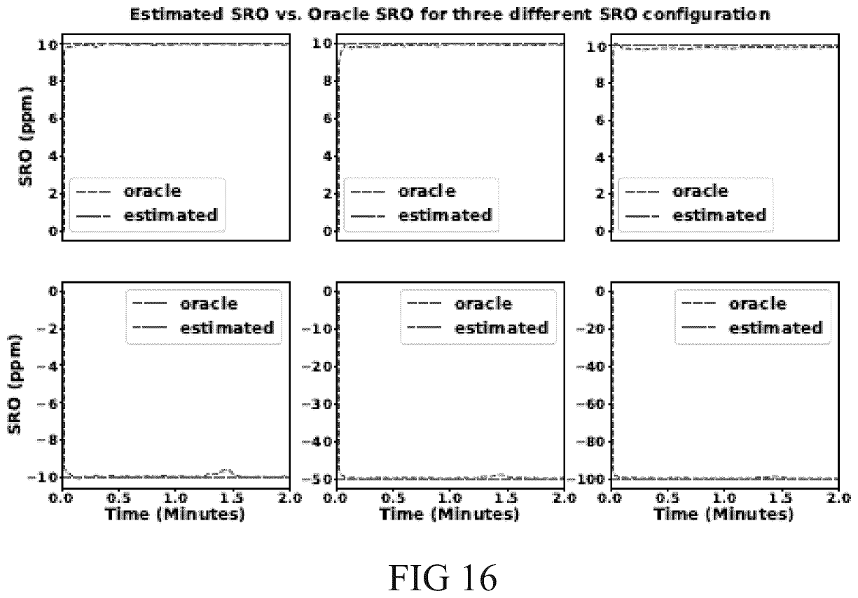

FIG. 16 illustrates plots for the estimated SRO for the first two minutes of the eight-minute file computed by averaging over seven different files. From the plots, it can be concluded that the estimated SRO is highly robust. In particular, FIG. 16 depicts an estimated SRO in ppm (top: \overline{\hat{ϵ}}₁, bottom: \overline{\hat{ϵ}}₂) vs. Oracle SRO for three different SRO configurations (left: [10, −10] ppm, mid: [10, −50] ppm, right: [10, −100] ppm) for the first two minutes.

Subjective listening tests using both real and synthetic stereo signals at two SRO configurations ([10, −10] ppm and [10, −100] ppm) following the Multiple Stimuli with Hidden Reference and Anchor (MUSHRA) methodology [50] were conducted with listeners with the following conditions: Hidden reference (black), oracle compensation (orange), oracle-RTF-based compensation (blue), no compensation (green) and anchor (grey). 25 s segments around the 6^{th} minute were extracted and binauralized using the impulse response corresponding to loudspeaker placed at ±90 deg before using it in the test [51]. For the anchor, at first, a passive downmix was computed, which was then low-pass filtered with a cut-off frequency of 3.5 kHz.

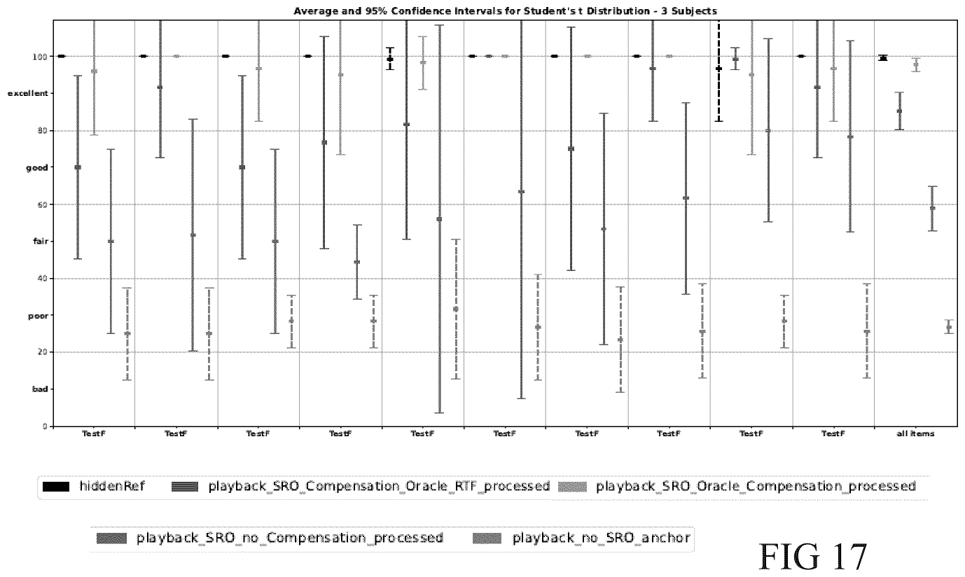

FIG. 17 illustrates a MUSHRA test for three listeners. In particular, From the MUSHRA results of FIG. 17 it can be concluded that SRO affects the listener's perception. The oracle-RTF-based compensation minimizes the effect of SRO on the listener's perception to a significant degree.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] Gerald Enzner and Peter Vary, “Frequency-domain adaptive Kalman filter for acoustic echo control in hands-free telephones,” Signal Processing, vol. 86, no. 6, pp. 1140-1156, June 2006.
[2] Sarmad Malik and Gerald Enzner, “Recursive Bayesian Control of Multichannel Acoustic Echo Cancellation,” IEEE Signal Processing Letters, vol. 18, no. 11, pp. 619-622, November 2011.
[3] Fabian Kuech, Edwin Mabande, and Gerald Enzner, “Statespace architecture of the partitioned-block-based acoustic echo controller,” in 2014 IEEE International Conference on Acoustics, Speech and Signal Processing (ICASSP), Florence, Italy, May 2014, pp. 1295-1299, IEEE.
[4] Gregory Ciccarelli, Jarred Barber, Arun Nair, Israel Cohen, and Tao Zhang, “Challenges and Opportunities in Multi-device Speech Processing,” in Proc. Interspeech 2022, 2022, pp. 709-713.
[5] Santiago Ruiz, Toon van Waterschoot, and Marc Moonen, “Distributed combined acoustic echo cancellation and noise reduction using gevd-based distributed adaptive node specific signal estimation with prior knowledge,” in 2020 28th European Signal Processing Conference (EUSIPCO), 2021, pp. 206-210.
[6] Santiago Ruiz, Toon van Waterschoot, and Marc Moonen, “Distributed combined acoustic echo cancellation and noise reduction in wireless acoustic sensor and actuator networks,” IEEE/ACM Transactions on Audio, Speech, and Language Processing, vol. 30, pp. 534-547, 2022.
[7] Mario Guggenberger, Mathias Lux, and Laszlo Böszörmenyi, “ClockDrift: a mobile application for measuring drift in multimedia devices,” in Proceedings of the 22nd ACM international conference on Multimedia, Orlando Florida USA, November 2014, pp. 767-768, ACM.
[8] Mario Guggenberger, Mathias Lux, and Laszlo Böszörmenyi, “An Analysis of Time Drift in Hand-Held Recording Devices,” in MultiMedia Modeling, Xiangjian He, Suhuai Luo, Dacheng Tao, Changsheng Xu, Jie Yang, and Muhammad Abul Hasan, Eds., vol. 8935, pp. 203-213. Springer International Publishing, Cham, 2015, Series Title: Lecture Notes in Computer Science.
[9] Enrique Robledo-Arnuncio, Ted S. Wada, and Biing-Hwang Juang, “On Dealing with Sampling Rate Mismatches in Blind Source Separation and Acoustic Echo Cancellation,” in 2007 IEEE Workshop on Applications of Signal Processing to Audio and Acoustics, New Paltz, NY, USA, October 2007, pp. 34-37, IEEE.
[10] Matthias Pawig, Gerald Enzner, and Peter Vary, “Adaptive Sampling Rate Correction for Acoustic Echo Control in Voice-Over-IP,” IEEE Transactions on Signal Processing, vol. 58, no. 1, pp. 189-199, January 2010.
[11] Mototsugu Abe and Masayuki Nishiguchi, “Frequency domain acoustic echo canceller that handles asynchronous A/D and D/A clocks,” in 2014 IEEE International Conference on Acoustics, Speech and Signal Processing (ICASSP), Florence, Italy, May 2014, pp. 5924-5928, IEEE.
[12] Robert Ayrapetian, Philip Hilmes, Mohamed Mansour, Trausti Kristjansson, and Carlo Murgia, “Asynchronous Acoustic Echo Cancellation OverWireless Channels,” in ICASSP 2021-2021 IEEE International Conference on Acoustics, Speech and Signal Processing (ICASSP), Toronto, ON, Canada, June 2021, pp. 116-120, IEEE.
[13] Karim Helwani, Erfan Soltanmohammadi, Michael Mark Goodwin, and Arvindh Krishnaswamy, “Clock Skew Robust Acoustic Echo Cancellation,” in Interspeech 2022. September 2022, pp. 2533-2537, ISCA.
[14] Joerg Schmalenstroeer, Jahn Heymann, Lukas Drude, Christoph Boeddecker, and Reinhold Haeb-Umbach, “Multistage coherence drift based sampling rate synchronization for acoustic beamforming,” in 2017 IEEE 19th International Workshop on Multimedia Signal Processing (MMSP), Luton, October 2017, pp. 1-6, IEEE.
[15] Aleksej Chinaev, Gerald Enzner, Tobias Gburrek, and Joerg Schmalenstroeer, “Online Estimation of Sampling Rate Offsets in Wireless Acoustic Sensor Networks with Packet Loss,” in 2021 29th European Signal Processing Conference (EUSIPCO), Dublin, Ireland, August 2021, pp. 1110-1114, IEEE.
[16] Tobias Gburrek, Joerg Schmalenstroeer, and Reinhold Haeb-Umbach, “On Synchronization of Wireless Acoustic Sensor Networks in the Presence of Time-Varying Sampling Rate Offsets and Speaker Changes,” in ICASSP 2022-2022 IEEE International Conference on Acoustics, Speech and Signal Processing (ICASSP), Singapore, Singapore, May 2022, pp. 916-920, IEEE.
[17] Joerg Schmalenstroeer and Reinhold Haeb-Umbach, “Efficient sampling rate offset compensation—an overlap-save based approach,” in 2018 26th European Signal Processing Conference (EUSIPCO), 2018, pp. 499-503.
[18] ITU-T, “P.862: Perceptual evaluation of speech quality (pesq): An objective method for end-to-end speech quality assessment of narrow-band telephone networks and speech codecs,” 2001.
[19] Yusuf Ziya Isik, Jonathan Le Roux, Zhuo Chen, Shinji Watanabe, and John R. Hershey, “Single-channel multi-speaker separation using deep clustering,” CoRR, vol. abs/1607.02173, 2016.
[20] Emanuel AP Habets, “Room impulse response (rir) generator,” 2008.
[21] Joerg Schmalenstroeer, Tobias Gburrek, and Reinhold Haeb-Umbach, “Libriwasn: A data set for meeting separation, diarization, and recognition with asynchronous recording devices,” in ITG conference on Speech Communication (ITG 2023), September 2023.
[22]M. M. Sondhi, D. R. Morgan, and J. L. Hall, “Stereophonic acoustic echo cancellation—an overview of the fundamental problem,” IEEE Signal Processing Letters, vol. 2, no. 8, pp. 148-151, 1995.
[23]T. Gansler and J. Benesty, “New insights into the stereophonic acoustic echo cancellation problem and an adaptive nonlinearity solution,” IEEE Transactions on Speech and Audio Processing, vol. 10, no. 5, pp. 257-267, 2002.
[24] Francis Rumsey, Spatial Audio, Music Technology Series. Taylor Francis, 2001.
[25] Agnieszka Roginska and Paul Geluso, Eds., Immersive Sound: The Art and Science of Binaural and Multi-Channel Audio, Audio Engineering Society Presents. Routledge, 2017.
[26] Franz Zotter and Matthias Frank, Ambisonics: A Practical 3D Audio Theory for Recording, Studio Production, Sound Reinforcement, and Virtual Reality, vol. 19 of Springer Topics in Signal Processing, Springer, 2019.
[27] Ville Pulkki, “Virtual sound source positioning using vector base amplitude panning,” Journal of the Audio Engineering Society, vol. 45, no. 6, pp. 456-466, June 1997.
[28] International Telecommunication Union, “Recommendation ITU-R BS.775-3: Multichannel stereophonic sound system with and without accompanying picture,” Tech. Rep., International Telecommunication Union, Geneva, Switzerland, 2012.
[29] International Telecommunication Union, “Recommendation ITU R BS.2159-6: Multichannel sound technology in home and broad casting applications,” Tech. Rep., International Telecommunication Union, 2013.
[30] International Organization for Standardization, “Information technology—Coding-independent code points—Part 3: Audio,” April 2018.
[31] Jon Francombe, Russell Mason, Philip J. B. Jackson, Tim Brookes, William J. Davies, Trevor Cox, Filippo Fazi, and Adrian Hilton, “Media device orchestration for immersive spatial audio reproduction,” in Proceedings of the 12th International Audio Mostly Conference, August 2017.
[32] Jon Francombe, James Woodcock, Richard J. Hughes, Russell Mason, Andreas Franck, Christopher R. Pike, Tim Brookes, William J. Davies, Philip J. B. Jackson, Trevor J. Cox, Filippo M. Fazi, and Adrian Hilton, “Qualitative evaluation of media device orchestration for immersive spatial audio reproduction,” Journal of the Audio Engineering Society, vol. 66, no. 6, pp. 414-429, June 2018.
[33] IEEE Instrumentation and Measurement Society, “IEEE Standard for a Precision Clock Synchronization Protocol for Networked Measurement and Control Systems,” July 2008.
[34]D. Mills, J. Martin, J. Burbank, and W. Kasch, “Network Time Protocol Version 4: Protocol and Algorithms Specification,” Request for Comments 5905, June 2010.
[35] Michael Culbert and Aram Lindahl, “Method and system for time synchronizing multiple loudspeakers,” March 2006.
[36] Christoffer Lauri and Johan Malmgren, “Synchronization of Streamed Audio Between Multiple Playback Devices Over an Unmanaged IP Network,” M. S. thesis, Lund University, October 2015.
[37] Barry D. Van Veen and Kevin M. Buckley, “Beamforming: A versatile approach to spatial filtering,” IEEE ASSP Magazine, vol. 5, no. 2, pp. 4-24, 1988.
[38]S. Markovich-Golan, S. Gannot, and I. Cohen, “Blind sampling rate offset estimation and compensation in wireless acoustic sensor networks with application to beamforming,” in International Workshop on Acoustic Signal Enhancement, 2012, pp. 1-4.
[39]L. Wang and S. Doclo, “Correlation maximization-based sampling rate offset estimation for distributed microphone arrays,” IEEE/ACM Transactions on Audio, Speech, and Language Processing, vol. 24, no. 3, pp. 571-582, 2016.
[40] Harry L. Van Trees, Optimum Array Processing: Part IV of Detection, Estimation, and Modulation Theory, Wiley-Interscience, Hoboken, NJ, USA, 2002.
[41]O. L. Frost III, “An algorithm for linearly constrained adaptive array processing,” Proceedings of the IEEE, vol. 60, no. 8, pp. 926-935, August 1972.
[42]S. Chakrabarty and E. A. P. Habets, “On the numerical instability of an Icmv beamformer for a uniform linear array,” IEEE Signal Processing Letters, vol. 23, no. 2, pp. 272-276, February 2016.
[43] Christopher M. Bishop, Pattern Recognition and Machine Learning, Springer, New York, NY, USA, 2006.
[44] Jingdong Chen, Jacob Benesty, and Yiteng Huang, “A minimum distortion noise reduction algorithm with multiple microphones,” IEEE Transactions on Audio, Speech, and Language Processing, vol. 16, no. 3, pp. 481-493, March 2008.
[45] Shmulik Markovich, Sharon Gannot, and Israel Cohen, “Multi-channel eigenspace beamforming in a reverberant noisy environment with multiple interfering speech signals,” IEEE Transactions on Audio, Speech, and Language Processing, vol. 17, no. 6, pp. 1071-1086, August 2009.
[46] Maja Taseska and Emanu″el A. P. Habets, “Relative transfer function estimation exploiting instantaneous signals and the signal subspace,” in Proceedings of the 23rd European Signal Processing Conference (EUSIPCO), Nice, France, August 2015, pp. 404-408.
[47] Robin Scheibler, Eric Bezzam, and Ivan Dokmani'c, “Pyroomacoustics: A python package for audio room simulation and array processing algorithms,” in Proceedings of the IEEE International Conference on Acoustics, Speech and Signal Processing (ICASSP), 2018, pp. 351-355.
[48] Tobias May, Steven van de Par, and Armin Kohlrausch, “A probabilistic model for robust localization based on a binaural auditory front-end,” IEEE Transactions on Audio, Speech, and Language Processing, vol. 19, no. 1, pp. 1-13, 2011.
[49] Majdak, Piotr, Hollomey, Clara, and Baumgartner, Robert, “Amt 1.x: A toolbox for reproducible research in auditory modeling,” Acta Acust., vol. 6, pp. 19, 2022.
[50] International Telecommunication Union, “ITU-R BS.1534-3: Method for the subjective assessment of intermediate quality level of audio systems,” October 2015.
[51] Chris Pike and Michael Romanov, “An impulse response dataset for dynamic data-based auralisation of advanced sound systems,” in Proceedings of the 142nd Audio Engineering Society Convention, Berlin, Germany, May 2017, Engineering Brief 334.

I/We claim:

1. An apparatus for interference cancellation, wherein the apparatus comprises:
a preprocessor configured for resampling a first audio signal to obtain a sampling-rate-adjusted first signal;
an interference estimator configured for estimating a first interference estimate depending on a first filter configuration and depending on the sampling-rate-adjusted first signal; and configured for estimating a second interference estimate depending on a second filter configuration and depending on a second audio signal;
a signal processor configured for processing a microphone signal or an intermediate signal, being a signal derived from the microphone signal, depending on the first interference estimate and depending on the second interference estimate to obtain an error signal; configured for updating the first filter configuration and the second filter configuration depending on the error signal; and configured for outputting the error signal;
wherein the preprocessor is configured to resample the first audio signal depending on a sampling rate offset between a sampling rate of the microphone signal or of the intermediate signal or of the error signal, and a sampling rate of the first audio signal.

2. An apparatus according to claim 1,
wherein the first audio signal is a far-end signal of a first device, and
wherein the microphone signal is a microphone signal of a second device being different from the first device.

3. An apparatus according to claim 2,
wherein the second audio signal is a far-end signal of the second device; or
wherein the second audio signal is a far-end signal of a third device being different from the first device and being different from the second device.

4. An apparatus according to claim 1,
wherein the preprocessor is configured to determine the sampling rate offset using the first audio signal or information on the first audio signal and using another signal or information on said other signal, wherein said other signal is the microphone signal or is the intermediate signal or is the error signal; and
wherein the preprocessor is configured to resample the first audio signal using the sampling rate offset.

5. An apparatus according to claim 4,
wherein the signal processor is configured to determine said other signal by determining the intermediate signal by subtracting a signal indicating the second interference estimate from the microphone signal, wherein the preprocessor is configured to determine the sampling rate offset using the intermediate signal or information on the intermediate signal, wherein the signal processor is configured to determine an error signal by subtracting a signal depending on the first interference estimate from the intermediate signal; or
wherein the apparatus is configured to determine a filtered audio signal by filtering the second audio signal using a third filter configuration, wherein the apparatus is configured to determine said other signal as a processed signal by subtracting the filtered audio signal from the microphone signal to determine said other signal, and is configured to update the third filter configuration depending on the processed signal, wherein the preprocessor is configured to determine the sampling rate offset using the processed signal or information on the processed signal; or
wherein the apparatus is configured to determine a filtered audio signal by filtering the second audio signal using a third filter configuration, wherein the apparatus is configured to determine a processed signal by subtracting the filtered audio signal from the microphone signal, and is configured to conduct, using beamformers, beamforming on the processed signal to determine said other signal, and is configured to update the third filter configuration depending on the processed signal, and wherein the preprocessor is configured to determine the sampling rate offset using outputs of the beamformers or information on the outputs of the beamformers; or
wherein the apparatus is configured to determine said other signal by performing, using beamformers, beamforming on the microphone signal to determine said other signal, and wherein the preprocessor is configured to determine the sampling rate offset using outputs of the beamformers or information on the output of the beamformers.

6. An apparatus according to claim 4,
wherein the preprocessor is configured to determine the sampling rate offset,
by determining a processed phase function depending on the first audio signal or a signal derived from the first audio signal and depending on said other signal, and
by determining a maximum value of a generalized cross-correlation of the processed phase function, wherein the processed phase function is represented in a time domain, when the maximum value of the generalized cross-correlation is determined.

7. An apparatus according to claim 6,
wherein the preprocessor is configured to determine the processed phase function in a time-frequency domain, and wherein the preprocessor is configured to transform the processed phase function from the time-frequency domain to the time domain; or
wherein the preprocessor is configured to determine the sampling rate offset by conducting a golden search in an interval around the maximum value of the generalized cross-correlation of the processed phase function; or
wherein, to determine the sampling rate offset: the preprocessor is configured to determine a coherence function as the coherence information, the preprocessor is configured to preprocess the coherence function to obtain a first phase function, and the preprocessor is configured to determine a smoothed phase function by autoregressive smoothing of the first phase function; wherein the processed phase function is the smoothed phase function or depends on the smoothed phase function.

8. An apparatus according to claim 4,
wherein the preprocessor is configured to determine the sampling rate offset by determining coherence information depending on a cross-correlation of the first audio signal or a signal derived from the first audio signal and said other signal, depending on an autocorrelation of the first audio signal or said signal derived from the first audio signal, and depending on an autocorrelation of said other signal.

9. An apparatus according to claim 8,
wherein the coherence information is determined depending on the formula:
$$Γ ( k , l ) = \frac{{Φ}_{E {X}^{2}} ( k , l )}{\sqrt{{Φ}_{EE} ( k , l ) {Φ}_{{X}^{2} {X}^{2}} ( k , l )}}$$
wherein Γ(k, l) indicates the coherence information, wherein k indicates a time index of a time-frequency domain, wherein l indicates a frequency index of the time-frequency domain, wherein ΦE X²(k, l) indicates the cross-correlation of the first audio signal or said signal derived from the first audio signal and said other signal, wherein ΦX² X²(k, l) indicates the autocorrelation of the first audio signal or said signal derived from the first audio signal, and depending on said other signal, wherein ΦEE(k, l) indicates the autocorrelation of said other signal; or
wherein the coherence information is not determined if no activity is detected in the first audio signal or if no activity is detected in said other signal; or
wherein, to determine the sampling rate offset, the preprocessor is configured to determine a coherence function as the coherence information, the preprocessor is configured to preprocess the coherence function to obtain a first phase function, the preprocessor is configured to determine a smoothed phase function by autoregressive smoothing of the first phase function.

10. An apparatus according to claim 1,
wherein the interference estimator is configured to employ Kalman filtering for estimating the first interference estimate and the second interference estimate.

11. An apparatus according to claim 1,
wherein the apparatus for interference cancellation is configured for conducting acoustic echo cancellation, wherein the interference estimator is configured as an echo estimator for estimating the first interference estimate, being a first echo estimate, depending on the first filter configuration and depending on the sampling-rate-adjusted first signal; and is configured for estimating the second interference estimate, being a second echo estimate, depending on the second filter configuration and depending on the second audio signal; wherein the signal processor is configured for processing the microphone signal or the intermediate signal, depending on the first echo estimate and depending on the second echo estimate to obtain the error signal.

12. An apparatus according to claim 1,
wherein the apparatus is configured for conducting acoustic echo cancellation in a teleconferencing system.

13. A method for interference cancellation, wherein the method comprises:
resampling a first audio signal to obtain a sampling-rate-adjusted first signal;
estimating a first interference estimate depending on a first filter configuration and depending on the sampling-rate-adjusted first signal; and configured for estimating a second interference estimate depending on a second filter configuration and depending on a second audio signal;
processing a microphone signal or an intermediate signal, being a signal derived from the microphone signal, depending on the first interference estimate and depending on the second interference estimate to obtain an error signal; configured for updating the first filter configuration and the second filter configuration depending on the error signal; and configured for outputting the error signal;
wherein resampling the first audio signal is conducted depending on a sampling rate offset between a sampling rate of the microphone signal or of the intermediate signal or of the error signal, and a sampling rate of the first audio signal.

14. A non-transitory computer-readable medium comprising a computer program for implementing the method of claim 13 when being executed on a computer or processor.

15. An apparatus for sampling rate offset compensation, wherein the apparatus comprises:
a sample rate offset determiner configured for determining a sampling rate offset introduced by a device,
a resampler configured for resampling, depending on the sampling rate offset, an initial reference signal to obtain a resampled reference signal,
wherein the sample rate offset determiner is configured to determine the sampling rate offset using a microphone signal or using a signal derived from the microphone signal.

16. An apparatus according to claim 15,
wherein the device introducing the sampling rate offset is a loudspeaker,
wherein the microphone signal used by the sample rate offset determiner to determine the sampling rate offset is recorded by a microphone which records sound waves emitted by the loudspeaker,
wherein the apparatus is configured to provide the resampled reference signal or a signal derived from the resampled reference signal to the loudspeaker.

17. An apparatus according to claim 16,
wherein the loudspeaker is a first loudspeaker,
wherein the sampling rate offset determined by the sample rate offset determiner is a first sampling rate offset,
wherein the resampled reference signal is a first resampled reference signal for being provided to the first loudspeaker,
wherein the sample rate offset determiner is configured for determining a second sampling rate offset introduced by a second loudspeaker,
wherein the resampler is configured for resampling, depending on the second sampling rate offset, the initial reference signal to obtain a second resampled reference signal,
wherein the apparatus is configured to provide the second resampled reference signal or a signal derived from the second resampled reference signal to the second loudspeaker.

18. An apparatus according to claim 17,
wherein the first sampling rate offset introduced by the first loudspeaker is different from the second sampling rate offset introduced by the second loudspeaker.

19. A method for sampling rate offset compensation, wherein the method comprises:
determining a sampling rate offset introduced by a device,
resampling, depending on the sampling rate offset, an initial reference signal to obtain a resampled reference signal,
wherein determining the sampling rate offset is conducted using a microphone signal or using a signal derived from the microphone signal.

20. A non-transitory computer-readable medium comprising a computer program for implementing the method of claim 19 when being executed on a computer or processor.
